(19) United States
(12) Patent Application Publication
(10) Pub. No.: US 2005/0101387 A1
(43) Pub. Date: May 12, 2005

(54) Bingo game morphed to display non-bingo outcomes

(75) Inventor: Bryan D. Wolf, Reno, NV (US)

Correspondence Address: BEYER WEAVER & THOMAS LLP, P.O. BOX 70250, OAKLAND, CA, 94612-0250, US

(73) Assignee: IGT

(21) Appl. No.: 10/937,227

(22) Filed: Sep. 8, 2004

Related U.S. Application Data
(60) Provisional application No. 60/592,410, filed on Jul. 30, 2004.
(60) Provisional application No. 60/503,161, filed on Sep. 15, 2003.

(51) Int. Cl. A63F 13/00

(52) U.S. Cl. 463/42; 463/19

(57) ABSTRACT

The present invention provides methods and devices for providing a bingo game having aspects of a non-bingo game such as a Class III game, preferably on a network of gaming machines. Some implementations of the invention provide a bingo game having aspects of a card game, such as a poker game. Some such implementations include a bingo card display in which areas of a bingo card correspond with playing cards. Preferred implementations provide games with easily recognizable bingo play. Accordingly, some implementations involve a 5×5 bingo card, wherein areas of the bingo card correspond with non-bingo symbols such as playing cards, and 75 randomly chosen numbers for game play. Bingo numbers are also assigned to areas of the bingo card, although these bingo numbers may or may not be displayed on the card. The randomly chosen numbers may be indicated by a “ball drop” involving a predetermined number of balls. Alternative implementations involve other types of bingo cards, including bingo cards with more or fewer areas, and the use of more or fewer than 75 randomly chosen numbers for game play.

### CROSS-REFERENCE TO RELATED APPLICATIONS

This application claims priority to U.S. Provisional Patent Application Nos. 60/592,410, entitled “Draw Bingo” and filed Jul. 30, 2004, and 60/503,161, entitled “Gaming Network with Multi-Player Bingo Game (Methods for Presentation of Bingo Outcomes in Gaming” and filed Sep. 15, 2003, both of which are hereby incorporated by reference for all purposes.

### BACKGROUND OF THE INVENTION

The present disclosure relates to gaming networks and, more particularly, to a gaming network providing a multi-player bingo game.

Gaming in the United States is divided into Class I, Class II and Class III games. Class I gaming includes social games played for minimal prizes, or traditional ceremonial games. Class II gaming includes bingo and bingo-like games. Bingo includes games played for prizes, including monetary prizes, with cards bearing numbers or other designations in which the holder of the cards covers such numbers or designations when objects, similarly numbered or designated, are drawn or electronically determined, and in which the game is won by the first person covering a previously designated arrangement of numbers or designations on such cards. Such an arrangement will sometimes be referred to herein as a “game-winning pattern” or a “game-ending pattern.” Class II gaming may also include pull tab games if played in the same location as bingo games, lotto, punch boards, tip jars, instant bingo, and other games similar to bingo. Class III gaming includes any game that is not a Class I or Class II game, such as a game of chance typically offered in non-Indian, state-regulated casinos.

Two basic forms of bingo exist. In traditional bingo, the players purchase cards after which a draw takes place. The first player to achieve a designated pattern wins. In one type of bingo game known as Bonanza Bingo, the draw for the game takes place before the players know the arrangements on their bingo cards. After the draw occurs, the players may purchase cards and compare the arrangements on the cards to the drawn numbers to determine whether predetermined patterns are matched. Play continues in Bonanza Bingo until at least one of the players matches a designated game-winning pattern. Bonanza Bingo may also encompass bingo variations wherein a partial draw is conducted for some numbers (generally fewer than the number of balls expected to be necessary to win the game) prior to selling the bingo cards. After the bingo cards are sold, additional numbers are drawn until there is a winner.

As indicated above, a bingo game is played until at least one player covers a predetermined game-winning pattern on the player's bingo card. The game may also include interim winners of prizes based on matching predetermined interim patterns on the bingo card using the same ball draw. The interim pattern wins do not terminate the bingo game. For interim pattern awards, players covering certain interim patterns may receive an additional award as the game continues. Some exceptional bingo versions may allow bingo draws beyond those needed to achieve the bingo game win so as to pay out interim pattern wins at a desired rate. The game-winning awards are generally pari-mutuel in nature. That is, the bingo win award is based upon the total amount wagered on a given occurrence of the bingo game. However, interim pattern awards typically are not pari-mutuel.

Gaming machines such as slot machines and video poker machines have proven to be very popular. However, many games of chance that are played on gaming machines fall into the category of Class III games, which may be subject to stricter approval and regulation. Many gaming establishments have a limited number of gaming machines for playing Class III games and a greater number of gaming machines for playing Class II games, such as bingo.

As such, it would be desirable to provide a gaming system wherein a Class II game may be played on a gaming machine with at least some of the “look and feel” of a Class III game, such as a slot game or a card game.

### SUMMARY OF THE INVENTION

The present invention provides methods and devices for providing a bingo game having aspects of a non-bingo game such as a Class III game, preferably on a network of gaming machines. Some implementations of the invention provide a bingo game having aspects of a card game, such as a poker game. Some such implementations include a bingo card display in which areas of a bingo card correspond with playing cards. Preferred implementations provide games with easily recognizable bingo play. Accordingly, some implementations involve a 5×5 bingo card, wherein areas of the bingo card correspond with non-bingo symbols such as playing cards, and 75 randomly chosen numbers for game play. Bingo numbers are also assigned to areas of the bingo card, although these bingo numbers may or may not be displayed on the card. The randomly chosen numbers may be indicated by a “ball drop” involving a predetermined number of balls. Alternative implementations involve other types of bingo cards, including bingo cards with more or fewer areas, and the use of more or fewer than 75 randomly chosen numbers for game play.

However, alternative embodiments use various N×N and N×M bingo cards, wherein N and M are predetermined integers. For example, some implementations use a 4×13 or a 13×4 bingo card, allowing each card of a 52-card deck to be mapped to the bingo card. Other implementations use card decks having more or fewer than 52 cards.

Some embodiments of the invention involve a gaming network for providing a wagering game. The gaming network includes at least one game server and a plurality of gaming machines configured to control an input of cash or indicia of credit for wagers for a wagering game and to control an output of cash or indicia of credit. The gaming network may include a wide-area network such as the Internet.

The game server and the plurality of gaming machines are configured to provide respective aspects of the wagering game. The wagering game involves the following: a plurality of non-bingo symbols; a set of bingo numbers provided for a player from a plurality of bingo numbers; an association of each of the bingo numbers to one of the non-bingo symbols; and a random draw of the bingo numbers. If a drawn bingo number is part of the set, the non-bingo symbol associated with the drawn bingo number is marked visually or displayed visually to the player. In some such implementations, a player is provided an award if the player is first from a plurality of players playing the wagering game against the player to accumulate a designated pattern of the visually marked non-bingo symbols.

The non-bingo symbols may be playing card symbols, slot symbols or other symbols. The designated pattern of the visually marked playing card symbols may be, for example, four of a kind, five of a kind, two pairs, a full house, a straight, a flush, a straight flush or a royal flush. In some implementations, the playing card symbols are marked visually in an array. The designated pattern may be of any configuration, including but not limited to a completed row, column or diagonal line of the array. However, the pattern does not necessarily include adjacent spots of the bingo card. The designated pattern of playing card symbols may be a playing hand of poker.

The set of values may be associated with a predetermined set of playing card symbols from the plurality of playing card symbols. In some implementations, the set of playing card symbols includes ten, jack, queen, king and ace symbols. The plurality of playing card symbols may be divided into any convenient number of suits, e.g., five suits. In one implementation, the suits include diamonds, hearts, spades, clubs and a fifth suit.

The bingo numbers may or may not be alphanumeric. Each of the bingo numbers may include a letter that is associated with one of a plurality of playing card suits. The associations between bingo numbers and non-bingo symbols may be varied randomly or may be fixed. The wagering game may provide an option of playing the game using and displaying the set of bingo numbers and/or the non-bingo symbols associated with the set of bingo numbers.

Alternative implementations of the invention also provide a gaming network for providing a wagering game. Some elements of the gaming network may be in communication via the Internet. The gaming network includes at least one game server and a plurality of gaming machines configured to control an input of cash or indicia of credit for wagers for a wagering game and to control an output of cash or indicia of credit. The game server and the plurality of gaming machines are configured to provide respective aspects of the wagering game.

The wagering game involves: a plurality of playing card symbols divided into a plurality of suits; a set of alphanumeric values provided for a player from a plurality of the alphanumeric values; an association of each of the bingo values to one of the playing card symbols; and a random draw of the values. Values having like letters may be associated with card symbols of the same suit. If a drawn value is part of the set, the playing card symbol associated with the drawn symbol is marked visually or visually displayed to the player. In some such implementations, the player is provided an award if the player is first from a plurality of players to accumulate a designated combination of the visually marked playing card symbols.

In some implementations, the cards are divided into five suits and the letters of the alphanumeric values include the letters, B, I, N, G and O. However, any convenient number of card suits may be used. Moreover, in alternative implementations the bingo numbers do not include letters. The designated combination of playing card symbols may include a card from each suit or cards from the same suit. The set of alphanumeric values may be associated with a fixed set of playing card symbols from the plurality of playing card symbols.

In some implementations, the set of playing card symbols may includes only tens, jacks, queens, kings and aces. However, alternative implementations use other playing cards. Some such implementations, for example, use all playing card symbols of a 52-card deck.

Still other aspects of the invention provide a method of providing a wagering game, including the following steps: choosing an amount of playing card symbols from which to make at least one winning hand of playing card symbols, the symbols separated into a plurality of suits; generating a like amount of alphanumeric values from a plurality of the values; forming a player set that includes each generated alphanumeric value, wherein each value has its respective letter associated with one of the suits of the playing cards and its respective number associated with a face value of one of the card symbols from the chosen amount of symbols; and enabling a player to play with the player set against at least one other player, each said player having at least one of their own player sets by drawing randomly the alphanumeric values to determine if the player's set of playing card symbols is generated first.

The step of enabling play may include comparing the generated alphanumeric values to the alphanumeric values of the player set to determine if a match occurs. The step of enabling play may include randomly generating values from the plurality of alphanumeric values, converting the generated values to their associated playing card symbols and comparing the converted playing card symbols with the winning hand of playing card symbols to determine if a match has occurred. The method may include converting the generated alphanumeric values to their respective playing card symbols and displaying the symbols if they match individually with one of the winning hands of playing card symbols.

Yet other aspect of the invention provides a method of conducting a bingo game involving a plurality of players. The method involves: forming a plurality of bingo cards by assigning a plurality of areas of each bingo card to corresponding non-bingo symbols; mapping bingo numbers to areas of the bingo cards, wherein the mapping differs as to at least some areas of each bingo card; providing at least some of the plurality of bingo cards to players, the plurality of areas of the bingo cards indicating the non-bingo symbols; randomly drawing the bingo numbers; indicating on each bingo card when a randomly drawn bingo number corresponds with a non-bingo symbol indicated on the bingo card; and selecting a winning player who achieves a highest-ranking pattern of hits on the bingo card.

The selecting step may be part of a process of selecting a plurality of winning players who achieve predetermined patterns of hits on their bingo cards. The bingo cards may be N×N bingo cards or N×M bingo cards, where N and M are predetermined integers. In one such implementation, N is 5. In another such implementation, N is 4 and M is 13. Alternatively, N may be 13 and M may be 4. The non-bingo symbols may or may not be playing card symbols.

The forming step may involve forming the plurality of bingo cards by assigning a first plurality of areas of a first set of bingo cards to a first set of corresponding non-bingo symbols and assigning a second plurality of areas of a second set of bingo cards to a second set of corresponding non-bingo symbols. The predetermined patterns may include “interim win” patterns. The predetermined patterns may correspond to playing card hands. In some such implementations, the first set of bingo cards and the second set of bingo cards are used for a single game. All of the foregoing methods, along with other methods of the present invention, may be implemented by software, firmware and/or hardware. For example, the methods of the present invention may be implemented by computer programs embodied in machine-readable media. The invention may be implemented by networked gaming machines, game servers and/or other such devices. These and other features and advantages of the invention will be described in more detail below with reference to the associated drawings.

### BRIEF DESCRIPTION OF THE DRAWINGS

FIG. 1 is a schematic flow diagram illustrating one method for creating bingo cards for the morphed bingo game of the present invention.

FIG. 2 is a schematic flow diagram illustrating one embodiment for playing a game according to the present invention.

FIG. 3A is an elevation view of a display device illustrating one embodiment of a bingo card of the present invention.

FIG. 3B is an elevation view of a display device illustrating another embodiment of a bingo card of the present invention.

FIG. 3C illustrates an alternative display, including a bingo card, for implementing some aspect of the present invention.

FIG. 3D is a schematic illustration of a mapping of bingo numbers to non-bingo symbols according to one example of the present invention.

FIG. 4 illustrates an exemplary Bingo card for implementing some aspects of the invention.

FIG. 5 illustrates an exemplary Bingo card for implementing alternative aspects of the invention.

FIG. 6 is a mapping chart that illustrates the mapping of the numbers of the Bingo card of FIG. 4 to their corresponding playing card images of the alternate Bingo card of FIG. 5.

FIG. 7 is a flow chart that provides an outline of some aspects of the invention.

FIG. 8 is a flow chart that provides an outline of other aspects of the invention.

FIG. 9 is a mapping chart that illustrates the mapping of drawn cards to their corresponding places on the display of FIG. 10.

FIG. 10 illustrates a display when a 1st card is drawn in one example of a game according to the present invention.

FIG. 11 illustrates a display when a 7th card is drawn in one example of a game according to the present invention.

FIG. 12 is a mapping chart that illustrates the mapping of drawn cards to their corresponding places on the display of FIG. 11.

FIG. 13 illustrates a display when a 52nd card is drawn in one example of a game according to the present invention.

FIG. 14 is a mapping chart that illustrates the mapping of drawn cards to their corresponding places on the display of FIG. 13.

FIGS. 15 and 16 illustrate an alternative mapping strategy according to the invention, wherein the columns of a Bingo card are each mapped to a corresponding rank of playing cards.

FIGS. 17 and 18A illustrate another mapping strategy according to the invention, wherein the numbers in a particular column may be mapped to the 10 through ace of a particular suit, but with the playing cards of the alternate game card being arranged such that each row corresponds to a royal flush for a particular suit.

FIG. 18B is an alternate game card according to some implementations of the invention.

FIG. 18C is an alternate game card according to some implementations of the invention.

FIG. 19 is a block diagram of a number of gaming machines in a gaming network that may be configured to implement some methods of the present invention.

FIG. 20 illustrates an exemplary gaming machine that may be configured to implement some methods of the present invention.

FIG. 21 is a block diagram of an exemplary network device that may be configured as a game server to implement some methods of the present invention.

### DESCRIPTION OF THE PREFERRED EMBODIMENTS

Reference will now be made in detail to some specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. Moreover, numerous specific details are set forth below in order to provide a thorough understanding of the present invention. The present invention may be practiced without some or all of these specific details. In other instances, well known process operations have not been described in detail in order not to obscure the present invention.

The present invention provides methods and devices for providing, preferably on a network of gaming machines, a bingo game having aspects of a non-bingo game, such as a card game or a slot game. The non-bingo game may be a Class III game, such as a card game or a slot game.

Some aspects of the present invention provide a primary or base wagering game and/or a secondary or bonus game. In various embodiments, the game includes a bingo game that is displayed on a gaming machine to appear like a slot game, a card game or other game. While adding variety to the display of bingo, the game still falls within the limits of the regulations of Class II gaming for bingo games. The game of the present invention can be implemented, for example, in a gaming device according to game data received from a game server. The gaming device may receive such game data through a dedicated gaming network and/or through a public data network such as the Internet.

Some implementations of the invention provide a bingo game having aspects of a card game, such as a poker game. Some such implementations include a bingo card display in which areas of a bingo card correspond with playing cards. As used herein, the term “bingo card” includes a traditional bingo card having areas populated with bingo numbers, as well as game cards having areas populated with non-bingo symbols, the areas and/or non-bingo symbols corresponding to bingo numbers. Bingo numbers may or may not be displayed on bingo cards of the present invention.

Preferred implementations provide games with easily recognizable bingo play. Accordingly, some implementations involve a 5×5 bingo card, wherein areas of the bingo card correspond with non-bingo symbols such as playing cards, and 75 randomly chosen numbers for game play. Bingo numbers are also assigned to areas of the bingo card, although these bingo numbers may or may not be displayed on the card. The randomly chosen numbers may be indicated by a “ball drop” involving a predetermined number of balls. Alternative implementations involve other types of bingo cards, including bingo cards with more or fewer areas, and the use of more or fewer than 75 randomly chosen numbers for game play.

In some embodiments, a gaming machine displays a game card to the player that includes areas within which playing cards are indicated instead of, or in addition to, bingo numbers. Because poker is a popular card game, much of the following discussion involves a bingo game having attributes of a poker game. However, in other implementations of the invention, the non-bingo game is another type of card game, a slot game, etc.

In some embodiments, a non-bingo game is provided as an option to the bingo player. That is, the bingo player can elect to play a normal version of bingo or play a bingo game having aspects of a non-bingo game.

Within the game of poker, different types of winning hands may be used. That is, in some embodiments illustrated below that are played using a 5×5 bingo card, the Ten, Jack, Queen, King and Ace of the four known suits of cards, plus an additional card suit, are used. The royal flush cards for the four suits and a new fifth suit may be used. In another embodiment, the Two, Three, Four, Five and Six cards can be used. In another embodiment, five cards of a same suit are used. Some bingo cards include one or more “joker” cards that may be used to represent any playing card.

In some embodiment, areas of a bingo card correspond to randomly generated bingo numbers. In some embodiments, the bingo numbers are displayed on the bingo card and in alternative embodiments, the bingo numbers are not displayed on the bingo card. The bingo numbers of the player's card are mapped to or associated with non-bingo symbols that are displayed on the bingo card. Preferably, the non-bingo symbols are associated with the same areas of each bingo card.

In some preferred embodiments, the bingo number corresponding to an area of a player's bingo card is mapped to a playing card symbol that is displayed in that area. For example, if the bingo number nine corresponds to the upper left-hand corner of the bingo card and the upper left-hand corner of the displayed bingo card of the present invention displays the Ten of Diamonds, then the bingo number 9 is mapped to or associated with the Ten of Diamonds on the game card displayed. In that manner, if the bingo number 9 is drawn during the game, the game of the present invention, having mapped that number to the Ten of Diamonds, marks the corresponding Ten of Diamonds spot as a “hit” on the displayed game card of the present invention. Some implementations require a player to mark such hits, e.g., within a predetermined time, or the hits will not count.

The underlying game may be played substantially the same way as a normal game of bingo. However, the player may see non-bingo symbols displayed on the bingo card(s) instead of (or in addition to) seeing bingo numbers. The non-bingo symbols may be playing cards that are arranged according to the rules of a card game, such as poker.

In some implementations wherein a bingo number can be drawn that is not a member of the displayed bingo card, the bingo number may be mapped to a non-bingo symbol that is not displayed on the game card. For example, a card game may involve a 52-card deck and the bingo card may have fewer than 52 areas wherein playing card symbols are displayed. In such implementations, drawn bingo numbers may be mapped to playing card symbols that are not displayed on the bingo card. Such playing card symbols may or may not be shown to the player. If the playing card symbols are shown to the player, they may be displayed, for example, as cards drawn from a deck and placed in a discard pile.

According to some implementations, the isomorphic game of the present invention is won by the first player who obtains a winning hand of cards. That player is the same player who, if playing traditional bingo, would have been the first player to receive hits in a predetermined pattern, e.g., five marked spots in a row, column or diagonally or another suitably predetermined game-winning pattern. The winner wins a suitable prize or credit amount associated with standard bingo gaming, and, in one embodiment, bingo gaming continues as with known bingo, wherein multiple bingo games are played in sequence. Alternative implementations provide for multiple “interim” winners who have hits on their bingo cards that complete other predetermined patterns. Such interim wins may be made without ending the game.

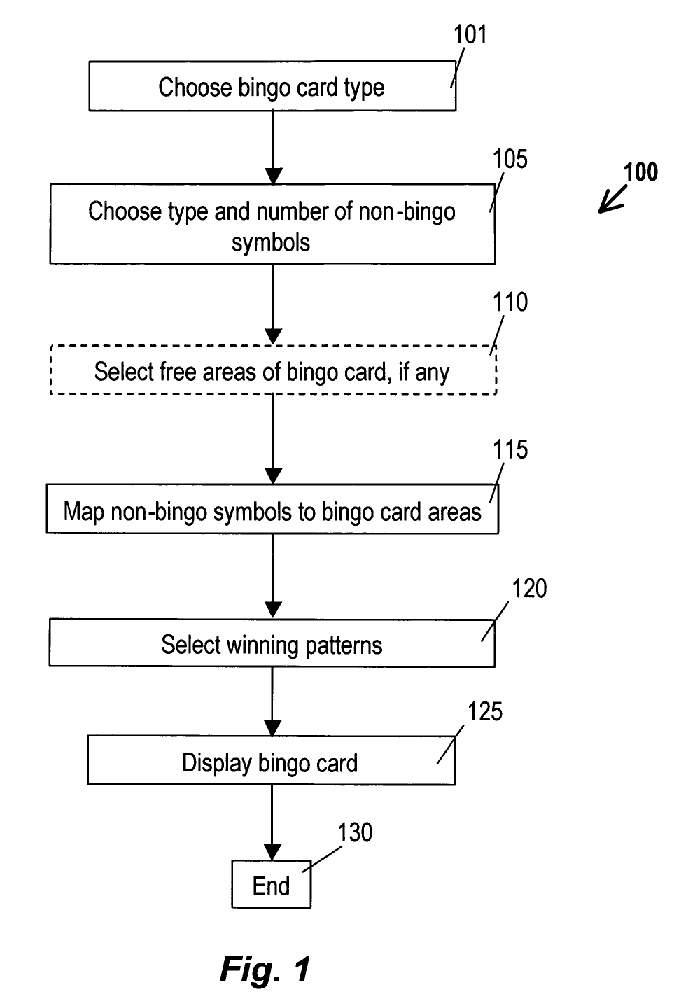

FIG. 1 is a flow chart that illustrates a method of forming bingo cards according to some aspects of the invention. The steps of method 100 may be performed by any convenient computing device and the results are made available to, e.g., a game server. In some implementations, a game server performs some or all of the steps of method 100. Those of skill in the art will appreciate that the steps of method 100 need not be performed (and in some implementations are not performed) in the order shown. Moreover, some implementations of method 100 may include more or fewer steps than those shown in FIG. 1.

In step 101, a bingo card type is selected. At this stage, the number of areas (a/k/a “spots,” which may be any convenient shape) of the bingo card is selected. As noted elsewhere herein, the present invention encompasses a wide variety of bingo card types, including the number of spots on the bingo card. In some implementations, a traditional 5×5 spot bingo card arrangement is used. However, alternative embodiments use various N×N and N×M bingo cards, wherein N and M are predetermined integers. In step 101, other aspects of the bingo card may also be selected, including overall bingo card layout, the type of lettering used for the card, how many areas of the card will be populated with non-bingo symbols, etc.

In step 105, the type and number of non-bingo symbols are selected in this example. The symbols will be appropriate for a selected non-bingo game. For example if selected non-bingo game is a card game, the non-bingo symbols will be playing card symbols. If the non-bingo game is a slot game, the non-bingo symbols could be symbols typically used in a slot game, such as fruit symbols.

The total number of non-bingo symbols may or may not equal the number of areas of the bingo card corresponding to the non-bingo symbols. For example, some implementations use a 4×13 or a 13×4 bingo card, allowing each card of a 52-card deck to be mapped to the bingo card. Other card game implementations use card decks having more or fewer than 52 cards.

In some implementations, not all bingo card “spots” or areas will correspond to a particular non-bingo symbol, but instead one or more “wild cards” or similar free areas will be arranged on the bingo card (step 110). In some card game implementations, one or more areas of the bingo card will indicate a “Joker” or similar playing card symbol, indicating that the area could correspond to any playing card.

In step 115, a correspondence or “mapping” is made between non-bingo symbols and areas of a bingo card. In preferred embodiments of the invention, the same mapping will be made for all bingo cards used for a particular game, such that all players of a particular game will be presented with the same arrangement of non-bingo symbols on the bingo card. However, as described elsewhere herein, each player's card will preferably have a different mapping between bingo numbers and the areas of the bingo card and/or the associated non-bingo symbols.

At least one, and preferably more than one, winning pattern is also selected for the bingo cards (step 120). Some preferred implementations include a game-winning pattern (e.g., a pattern such as that associated with a conventional bingo game) and other patterns for “interim wins” that correspond with the non-bingo game. For example, completing a row, column or diagonal of a bingo card could win a game, but completing other patterns could entitle a player to a lesser prize. A progressive pattern may also be established. Details of some such implementations will be discussed further below.

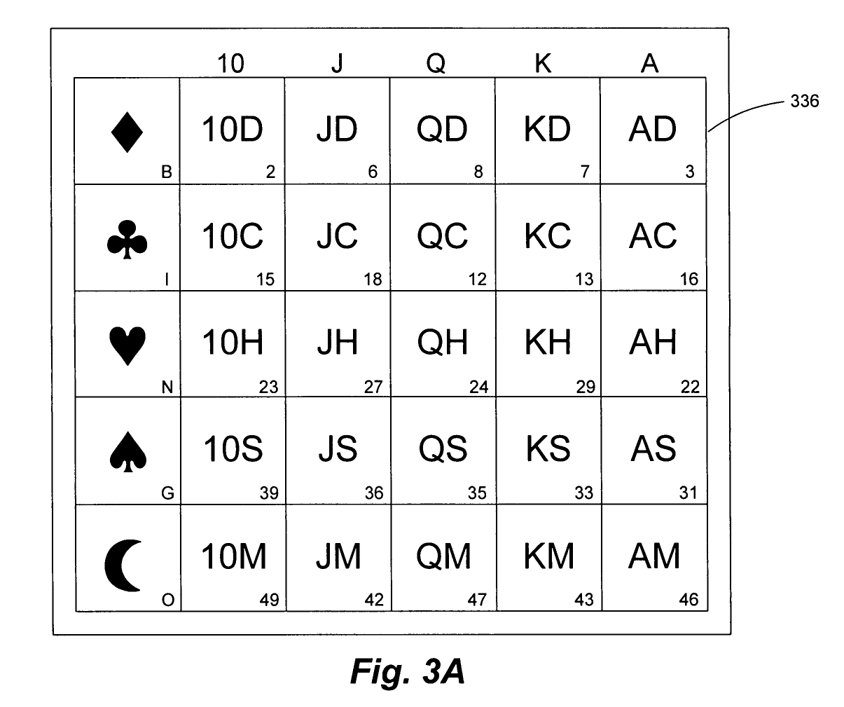

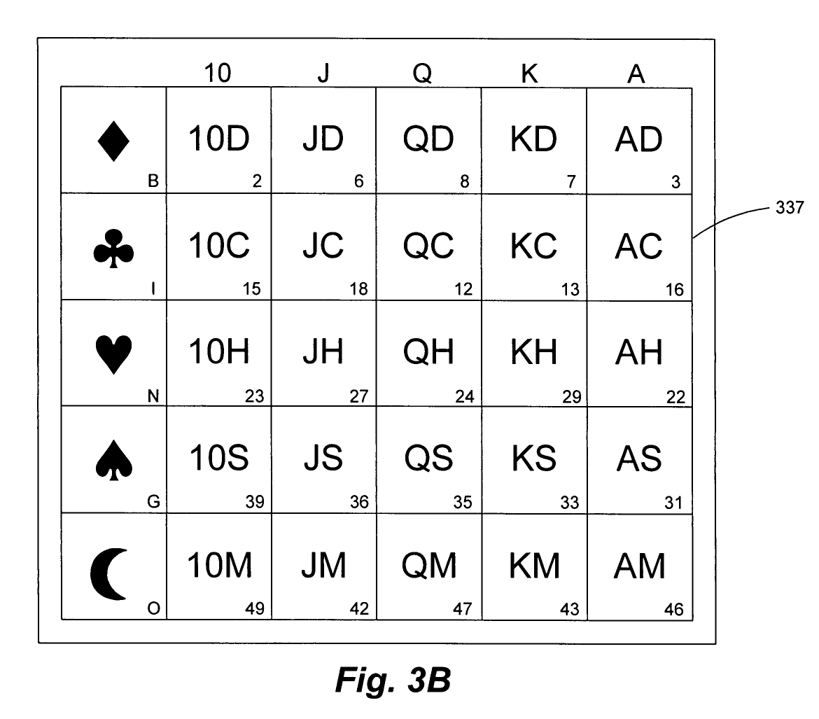

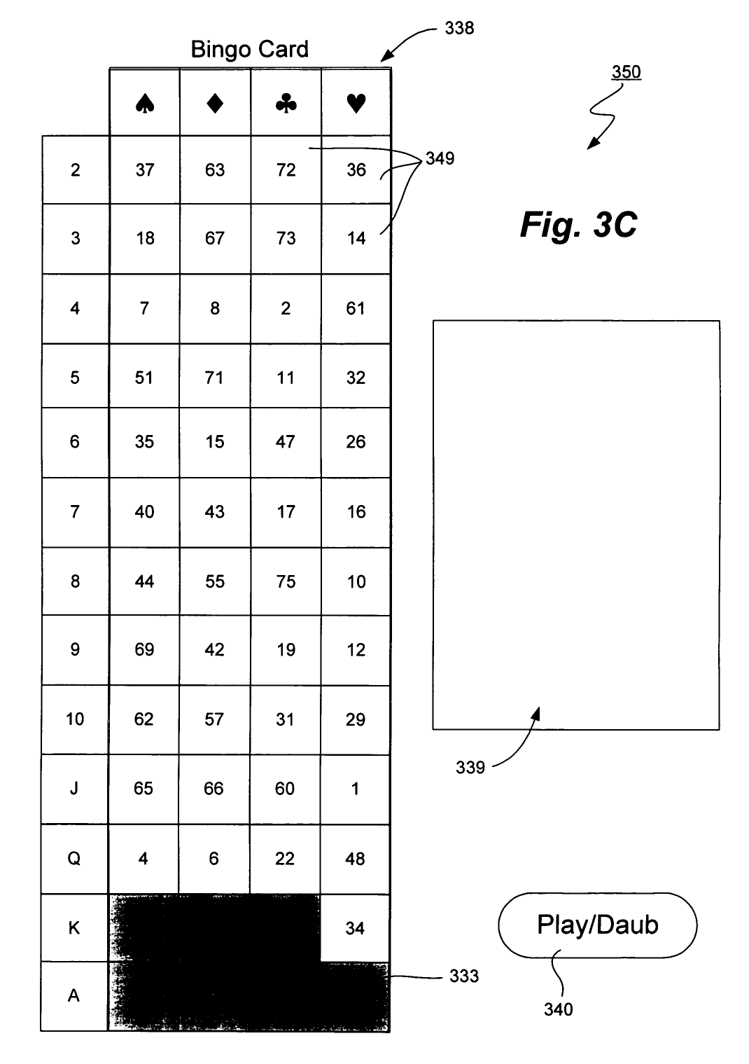

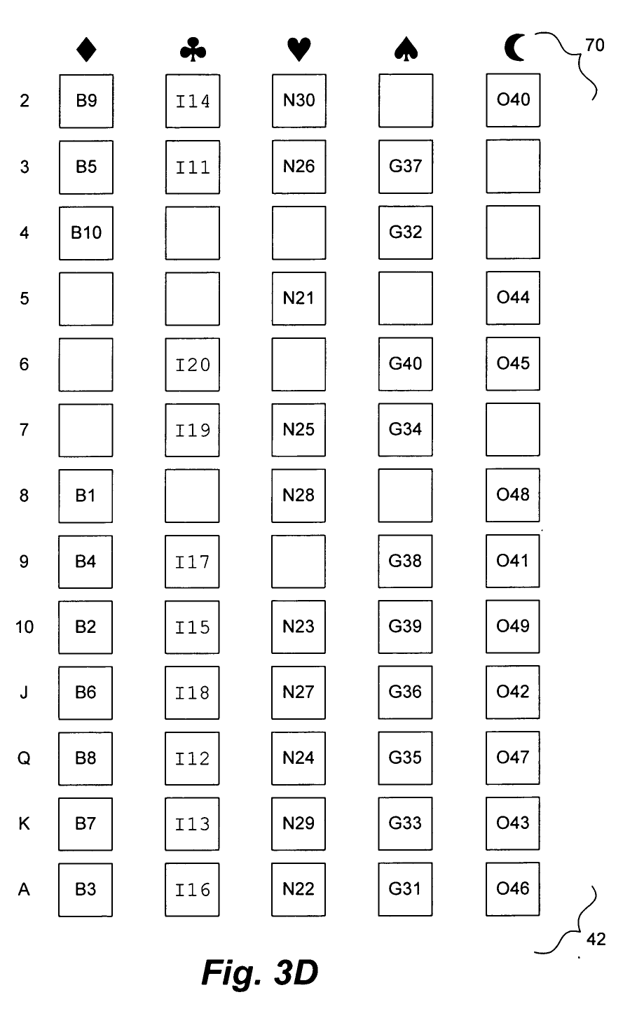

In step 125, the bingo card is displayed with non-bingo symbols indicated on the bingo card. Some exemplary bingo card displays are illustrated in FIGS. 3A-3C, which are described below. The game-winning pattern and the progressive pattern (if any) may or may not be displayed on the bingo card. However, if the game provides for various interim win patterns, these interim win patterns are preferably not all displayed on the bingo card.

In this example, the non-bingo symbols are displayed in areas of the bingo card. Within the set of card game implementations, there are various alternative ways that playing cards may be indicated according to the present invention. For example, the rows may indicate playing card suits and the columns may indicate playing card values, or vice versa. According to such implementations, the individual areas of the bingo card may or may not indicate a playing card symbol, but will still be associated with an individual playing card.

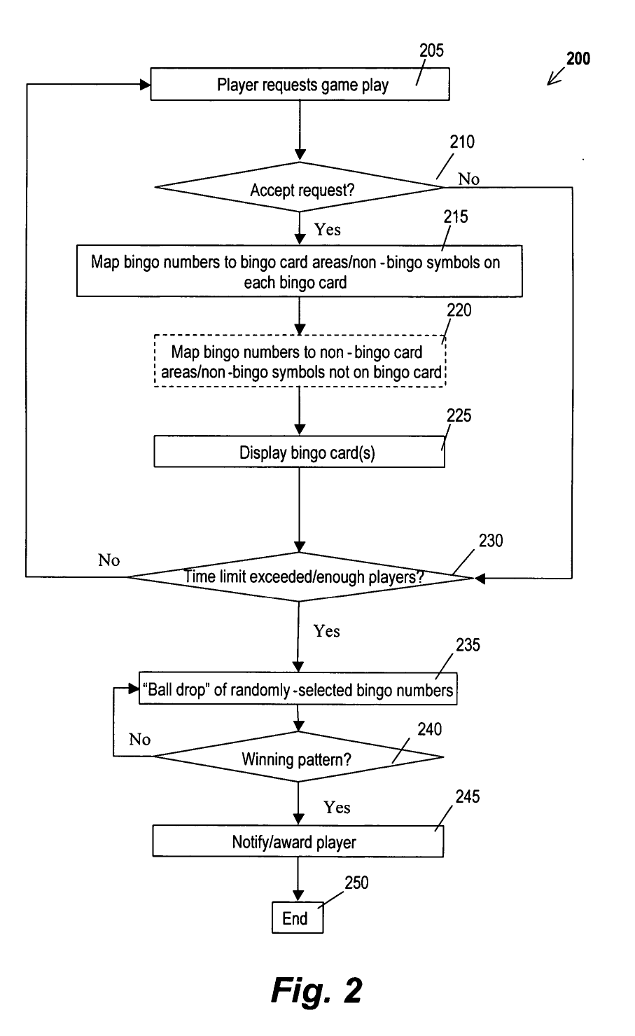

FIG. 2 is a flow chart that outlines some methods 200 of providing games according to the present invention. In some preferred implementations, the steps of method 200 are performed by devices in a gaming network: for example, some steps of method 200 may be performed by one or more gaming machines and some steps may be performed by a game server. Those of skill in the art will appreciate that the steps of method 200 need not be performed (and in some implementations are not performed) in the order shown. Moreover, some implementations of method 200 may include more or fewer steps than those shown in FIG. 2.

In step 205, a player requests game play. For example, the player may insert a payment document into a gaming machine and select a game according to the present invention. The gaming machine would then send a request to a game server for a bingo card appropriate for the selected game. In this example, the bingo card layout, the non-bingo symbol arrangement, etc., have already been established according to method 100 or otherwise.

In preferred implementations, only one type of bingo card is available for a particular game. However, in some implementations, the player is provided different bingo card options, even for a particular selected game. For example, the player would be able to select “Poker” and also to select from a variety of N×N or N×M bingo card layouts for playing poker, e.g., 5×5 or 4×13. For implementations in which players competing in the same game may choose different card layouts, the winning patterns should be selected such that the size of the card and the shape of the pattern do not matter. If two players playing differently sized bingo cards are competing to complete patterns that may be different shapes, but have the same number of spots, they both have the same chances of winning.

In step 210, it is determined whether the request should be accepted. For example, a game server may authenticate the request to determine whether the request originated from a trusted source, such as a known gaming machine. If the request is not accepted, the method proceeds to step 230. In some implementations, the player (or the gaming machine) may be provided with one or more additional chances to submit an acceptable request. If a request is accepted, the method proceeds to step 215.

In this example, individual bingo cards are created in response to individual player requests to play a game. Accordingly, in step 215, bingo numbers are randomly mapped to areas and/or non-bingo symbols of a bingo card for the selected game. In alternative implementations, a number of bingo cards may be prepared in advance instead of waiting for a player to request a bingo card. It will be appreciated that a tangible bingo card may or may not be created, according to the implementation. For example, in some preferred implementations a game server may actually prepare an electronic representation of a bingo card.

In some implementations, the number of available bingo numbers will exceed the number of areas on a bingo card to which the bingo numbers will be mapped. For example, if a conventional 5×5 bingo card is used for displaying selected playing cards of a 52-card deck, not all playing cards of the deck will be represented on the bingo cards. Therefore, in optional step 220, bingo numbers may be mapped to non-bingo symbols (in this example, playing card symbols) that are not indicated on the bingo cards used for game play.

The bingo card is then displayed to the player (step 225). In some implementations (e.g., if the bingo numbers are indicated on the card), the player may be allowed to select a different bingo card. Moreover, some implementations of the invention allow a player to play multiple bingo cards during the same game. However, in the present example, the player does not have these options.

In step 230, it is determined whether the game should begin. For example, a game server may wait for a predetermined time for additional players to request the game prior to initiating game play. Alternatively, or additionally, the game server may require that a minimum number of players request the game before initiating game play. The minimum number and/or predetermined time may vary, e.g., according to the date and/or time of day. For true bingo, at least 2 players must play a game.

After play is initiated, a “ball drop” of randomly selected bingo numbers is made (step 235). At least some aspects of the “ball drop” are indicated to the players, either directly or indirectly. As one example of an “indirect” method, the players may only know when there is a “hit” or correspondence between the bingo number and an area/bingo card symbol on their bingo card(s). For example, when there is a hit, part or all of the area may be displayed differently. In some implementations, a mark may appear in the area, such as an “X” or an “O.” In other implementations, a non-bingo symbol in the area will be displayed differently (e.g., with higher contrast, brighter, in color or with different colors) after there is a hit.

In some examples of “direct” methods, bingo numbers and/or non-bingo symbols may be displayed to the players whether or not there is a hit. In some implantations, for example, bingo numbers and/or non-bingo symbols are displayed in a separate portion of a display screen or on a different display screen of a gaming machine. Hits are also indicated on the bingo card and/or elsewhere. Some such examples are described below.

In step 240, it is determined (e.g., by the game server) whether a prize-winning pattern has been completed on a bingo card of any player. The prize-winning pattern may be a game winning pattern or an “interim win” pattern. If no prize-winning pattern has been completed, the ball drop continues. If a prize-winning pattern has been completed, the winner is notified and a prize awarded (step 245). In some implementations, a player is required to “daub” a pattern (e.g., within a predetermined time) in order to claim a prize. In other implementations, the player is not required to daub and/or the gaming machine will automatically daub. If the pattern was an “interim win” pattern, the ball drop continues. If the pattern was a game-winning pattern, the game ends. In some implementations, a player who completes an interim win may choose to continue play and try for a game-winning pattern. In some such implementations, choosing to continue play may require the player to reject the award for the interim win or to pay an additional fee for continued play.

FIG. 3A is an elevation view of a display device illustrating one embodiment of a bingo card of the present invention. Bingo card 336 may be displayed, for example, on a display device of a gaming machine. In an alternative embodiment, card 336 is displayed in a live bingo game at a casino or bingo hall. Here, the card can appear on one of a plurality of video monitors provided at the casino or hall or on a large video monitor or display along with other bingo cards.

Bingo card 336 is used somewhat differently from conventional bingo cards. In conventional bingo, the cards all appear differently from one another, as each card contains bingo numbers in different areas of the bingo card. In preferred implementations of the present invention, the bingo cards for each player do not appear to be different, but instead indicate the same arrangement of non-bingo symbols. In FIG. 3A, exemplary bingo numbers corresponding to the areas and non-bingo symbols of bingo card 336 are indicated for reference. However, these bingo numbers are not displayed in all implementations of the invention.

Each card preferably has a different mapping between the displayed non-bingo symbols and bingo numbers. For example, a player using bingo card 336 will receive a “hit” on the Ten of Diamonds if a bingo number 2 is drawn. However, some or even all other players may not have a hit indicated for the Ten of Diamonds when a 2 is drawn. Instead, those players are required to have the bingo number drawn that is matched to their Ten of Diamonds in order for that card to be hit.

In this example, bingo card 336 includes the four standard card suits, namely, Diamonds, Clubs, Hearts and Spades. Because this implementation is using a 5×5 bingo card, a fifth card suit is also used: as shown by bingo card 336, the fifth card suit is the suit of Moons or Half-Moons.

On bingo card 336, the card suits are each associated with one of the letters of bingo. Here, the suit of Diamonds is associated with the letter “B.” The suit of Clubs is associated with the letter “I.” The suit of Hearts is associated with the letter “N.” The suit of Spades is associated with the letter “G.” The suit Moons is associated with the letter “O.” Those associations can be determined and varied randomly or fixed.

While standard playing cards are shown in the illustrated embodiment, it should be appreciated that any type of cards or symbols other than bingo numbers can be used. For example, instead of five different card suits for a 5×5 bingo card, the game could use five different slot symbols or any other type of convenient non-bingo symbols. Once non-bingo symbols are chosen to be associated with the different areas of the bingo card, members from each of those sets or suits are selected to form a winning sub-set or hand.

In this example, the Ten, Jack, Queen, King and Ace of each suit are used to form the winning subsets or hands of the overall set. That is, the Two through Nine cards of each suit still exist but are not part of the displayed bingo card 336. Those numbers may instead be matched to bingo numbers that are drawn but which do not appear on bingo card 336. As noted elsewhere herein, in some embodiments all cards shown on a bingo card may belong to the same suit.

In some preferred implementations, when the player daubs a card goes to the spot to which it is mapped. However, each area of the bingo card does not necessarily map to an unique card. In some implementations, for example, 2 or more spots can map to the same card. Thus, the player's bingo card may have, e.g., 5 spots that could map to the King of Diamonds. In some such implementations, the player will not know which spot on the bingo card (in this example, which King of diamonds) maps to the drawn card until he or she daubs. Such implementations further increase player anticipation and excitement. In other implementations having non-unique card mappings, the player may choose one spot among 2 or more spots on the bingo card corresponding to the drawn card. For example, the player may select the spot by touching a corresponding portion of a display screen. In yet other implementations having non-unique card mappings, the spot on the bingo card is chosen as soon as the card is drawn.

Bingo card 336 illustrates that each row of cards forms a royal flush, while each column of cards forms five of a kind. It is preferred that the winning patterns make sense from the standpoint of a non-bingo game, such as poker in this example. Accordingly, the diagonal lines of five cards each form an Ace-high straight. Other possible winning poker combinations include two pair, a full house, a straight and four of a kind. Some of these hands may be designated as “interim win” patterns for game play. Whenever the player obtains such patterns on a bingo card, it also appears that the player achieves a prize-winning poker hand. In that way, the underlying bingo game appears as a poker game. However, the spots that form a game-winning hand need not be contiguous: any pattern having the proper number of spots may be mapped to a poker hand. Moreover, as noted elsewhere herein, the present invention is not limited to the use of 5×5 bingo cards: the bingo cards used may have varying numbers of areas/spots, according to various implementations of the invention.

For illustrative purposes, bingo card 336 also illustrates the player's natural bingo numbers, i.e., from a bingo draw, in the lower right-hand corner of each square. In the row of “B” or Diamonds numbers, the player has drawn the two, six, eight, seven and three. In the row of “I” or Clubs numbers, the player has drawn the fifteen, eighteen, twelve, thirteen and sixteen. In the row of “N” or Hearts numbers, the player has drawn the twenty-three, twenty-seven, twenty-four, twenty-nine and twenty-two. In the row of “G” or Spades numbers, the player has drawn the thirty-nine, thirty-six, thirty-five, thirty-three and thirty-one. In the row of “O” or Moon numbers, the player has drawn the forty-nine, forty-two, forty-seven, forty-three and forty-six. Those drawn numbers are the numbers that would appear in a natural or normal bingo game on a natural or normal bingo card.

In conventional bingo, the middle square, or free space, is provided automatically to the player. The morphed bingo game of the present invention may or may not employ a similar feature. That is, the game and gaming device of the present invention could automatically provide the Queen of Hearts to each of the players. In such a case, that card is not mapped to one of the players' natural bingo numbers. In an alternative embodiment, the Queen of Hearts is not provided to the player and is instead mapped to a natural drawn bingo number provided in the middle position on the bingo card 336.

Standard bingo uses fifteen different numbers per letter. That is, numbers one through fifteen are typically associated with letter “B”, the numbers sixteen through thirty are associated with the letter “I”, etc. However, games according to the present invention are in no way constrained by this convention: bingo numbers may or may not be associated with a letter and any convenient range of bingo numbers may be used. For example, in some embodiments illustrated in the present invention, the game associates ten numbers with each suit instead of fifteen. It should be appreciated that other ranges of numbers could alternatively be used. In some implementations, thirteen numbers, one corresponding to each card of a suit of a standard deck of playing cards, are used for each suit displayed on the bingo card.

FIG. 3B is an elevation view of a display device illustrating an alternative embodiment of a bingo card of the present invention. Bingo card 337 is quite similar to bingo card 336. However, bingo card 337 includes a joker symbol (“JK”) as a free area or “wild card.”

FIG. 3C illustrates display 350 that includes another exemplary bingo card of the present invention. Display 350 includes 4×13 bingo card 338. In this example, the areas 349 of bingo card 338 correspond with playing cards of a standard 52-card deck. Here, no playing card symbols are displayed in the areas, yet each area indicates a different playing card, according to the row and column of each area 349. In this example, the corresponding bingo numbers are displayed in each of areas 349. Darkened area 333 indicates a game-winning pattern, which is also a progressive pattern in this example.

Display 350 also includes area 339 for directly indicating random numbers (sometimes referred to herein as “ball drop” numbers or the like) that are displayed during game play. Area 339 may display, for example, numbered balls, non-bingo symbols with or without numbers, etc. In this example, display 350 includes “Play/Daub” button 340, which allows a player to give daub (or other) commands when appropriate.

FIG. 3D illustrates a data structure in an area of a memory device (such as a memory device accessible to a game server), which indicates one exemplary mapping between bingo numbers and non-bingo symbols according to some aspects of the present invention. This mapping may take place, for example, in steps 215 and 220 of method 200, or in similar steps of a comparable method. In this example, the steps are performed by a game server in response to a player's approved request for playing a game.

A map 70 illustrates each of the associations between bingo numbers and playing cards on game card 336 of FIG. 3A. The bingo values B2, B6, B8, B7, B3, I15, I18, I12, I13, I16, N23, N27, N24, N29, N22, G39, G36, G35, G33, G31, O49, O42, O47, O43 and O46 are randomly selected. The game server then maps those bingo numbers to match the playing cards of game card 336. In the illustrated embodiment, the game matches the above drawn bingo numbers to the Ten through Ace of Diamonds, Ten through Ace of Clubs, Ten through Ace of Hearts, Ten through Ace of Spades, and Ten through Ace of Moons, respectively.

Table 70 also illustrates that the server maps the bingo numbers that were not drawn for the player to playing cards that are not part of the game card 336. Because there are thirteen playing cards per suit, and only ten numbers per bingo letter in this example, each suit will have three non-matched playing card values. As stated above, in one alternative embodiment, a game server provides thirteen numbers per bingo letter and therefore matches each of the playing card numbers. Again, the bingo numbers used for implementing the present invention need not be associated with the letters B, I, N, G and/or O.

In the illustrated embodiment using table 70, the game server maps the remaining “B” numbers, namely, B9, B5, B10, B1 and B4 randomly and respectively to the playing cards of the Two of Diamonds, Three of Diamonds, Four of Diamonds, Eight of Diamonds, and Nine of Diamonds, respectively. The non-drawn bingo numbers I14, I11, I20, I19 and I17 are mapped randomly and respectively to the playing cards of the Two of Clubs, Three of Clubs, Six of Clubs, Seven of Clubs, and Nine of Clubs. The non-drawn bingo numbers N30, N26, N21, N25 and N28 are mapped randomly and respectively to the Two of Hearts, Three of Hearts, Five of Hearts, Seven of Hearts and Eight of Hearts. The non-drawn bingo numbers G37, G32, G40, G34 and G38 are mapped randomly and respectively to the playing cards of the Three of Spades, Four of Spades, Six of Spades, Seven of Spades and Nine of Spades. The non-drawn bingo numbers O40, O44, O45 and O48 are mapped randomly and respectively to the player cards of the Two of Moons, the Five of Moons, the Six of Moons, the Eight of Moons and the Nine of Moons, respectively.

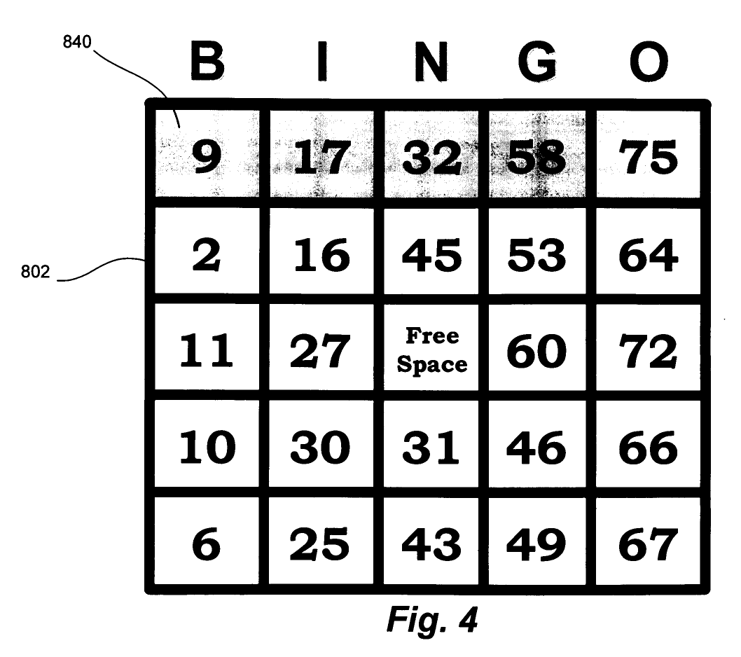

The game cards for traditional bingo games typically include a 5×5 array of numbers from the range of 1-75 as described above. In order to potentially appeal to a broader audience of casino patrons, it may be desired to configure the multi-player bingo games such that the game cards use varying symbols and/or arrays for the playing the bingo game and displaying the outcome of the bingo game. In some implementations, the numbers of the traditional bingo game card may be replaced with playing cards in order to at lease loosely simulate a poker game. Some such exemplary methods will be described in detail with reference to FIGS. 4 through 18.

FIG. 4 illustrates a traditional bingo card 802 that will be used as a reference for some of the following discussion. The traditional bingo game card may be assigned to or selected by the player, and then have the numbers of the bingo game card mapped to playing cards arranged on a poker bingo game card. After the numbers are mapped to the poker bingo game cards, the poker bingo game card may be displayed to the player during the occurrence of the bingo game. The bingo numbers may be randomly drawn in the same manner as the traditional bingo game.

If the drawn number matches a number on a player's bingo game card and, consequently, a playing card to which the number is mapped, the corresponding playing card of the poker bingo game card may be marked to signify the match. If the drawn number does not match a number on the player's bingo game card, no playing cards are marked. Numbers may be drawn until a pattern is matched on a player's poker bingo game card corresponding to an “interim win” pattern and/or a predetermined game-winning pattern on the bingo game card. If necessary, the player may then daub the poker bingo game card to claim the game-winning prize. Various embodiments and variations of games morphed to display bingo game outcomes will now be described more fully.

For the purpose of illustration, the bingo game card 802 for the first player previously described and shown in FIG. 4 may be the underlying bingo game card for a player playing a game morphed to display a bingo game outcome. The illustrated bingo game card 802 for the first player, which is a traditional bingo game card, was previously described as having a 5×5 array of numbers, with the numbers in the first or “B” column selected from the range of 1 to 15, the numbers in the second or “I” column selected from the range of 16-30, the numbers in the third or “N” column selected from the range of 31-45, and with the center square being a “Free Space,” the numbers in the fourth or “G” column selected from the range of 46-60, and the numbers in the fifth or “O” column selected from the range of 61-75. In addition, the predetermined game-winning pattern 840 for the occurrence of the multi-player bingo game, which in this example is matching the five numbers across the top row of the bingo game card 802, may be highlighted on the bingo game card 802 for those players opting to have the bingo game card 802 displayed for the outcome of the occurrence of the bingo game.

Players of the multi-player bingo game may be offered the option of displaying the outcome of the occurrence of the bingo game on an alternate card using symbols other than numbers. In one embodiment, an alternate bingo game card 1000 illustrated in FIG. 5 may include a 5×5 array of images representing playing cards 1002. The game card 1000 presents a simple alternative mapping strategy wherein the columns of numbers of the bingo game cards 802 may be replaced with columns of suited playing cards. The playing card images 1002 may be arranged with one suit corresponding to each column of the bingo game card 802 so that each playing card image 1002 in a column of the game card 1000 has the same suit.

In this example, the suit of diamonds corresponds to the first or “B” column, and the suits of spades, hearts, clubs, and an additional suit of stars may correspond to the “I,” “N,” “G,” and “O” columns, respectively, of the game card 802. The additional suit, which may be any suit desired by the designers of the multi-player bingo game, may be added to facilitate a one-to-one correspondence between the numbers of the bingo game card 802 and the playing card images of the game card 1000. Within each column, the game card 1000 may include images of the ace, king, queen, jack and ten of the corresponding suit arranged in descending order of rank of playing cards. Arranged in this way, each column includes the playing cards necessary for a royal flush for the corresponding suit, and each row includes five of a kind (e.g., five aces across the first row). Further, each diagonal line of the array includes the cards necessary for an ace-high straight with one card from each of the five suits.

In the multi-player bingo game described above, each player for an occurrence of the bingo game preferably has an unique bingo game card 802 and, consequently, a unique chance of matching the game-winning and interim patterns, and has an unique display of a bingo game card 802 at the corresponding gaming unit 20. When the alternate game card 1000 is used by the players, the players may each have a similar (or identical) initial display of the alternate game card 1000 at the gaming unit 20, but the uniqueness of the players' entries and chances of matching the game-winning and interim patterns may be retained by mapping the numbers of the players' bingo game cards 802 to the playing card images 1002 of the alternate game cards 1000. In the present embodiment, the bingo game may implement a one-to-one mapping of the numbers of the bingo game cards 802 to the playing card images 1002 of the alternate game cards 1000.

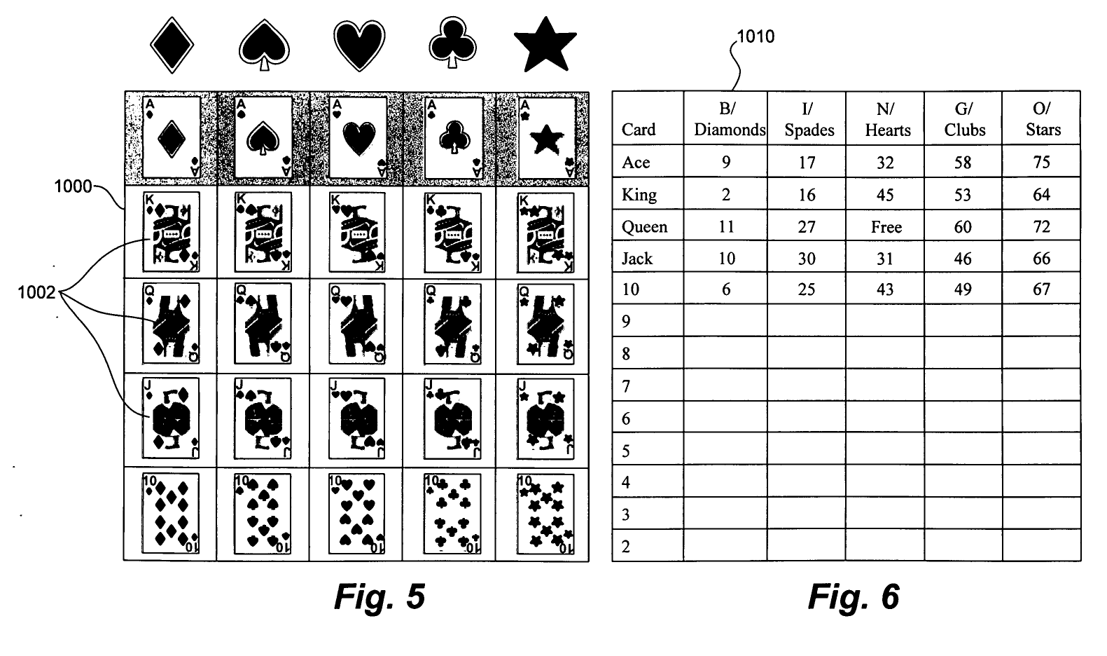

A mapping chart 1010 shown in FIG. 6 illustrates the mapping of the numbers of the bingo game card 802 of FIG. 4 to their corresponding playing card images 1002 of the alternate game card 1000 of FIG. 5. The left-most column of the mapping chart 1010 may list the playing cards of a traditional deck of cards in descending order of rank, with the following columns representing the columns “B,” “I,” “N,” “G” and “O” of the game card 802 and corresponding suits of the game card 1000. In the mapping chart 1010, each number of bingo game card 802 is entered in the appropriate location for the playing card occupying the same row and column as the number.

For example, the number “9,” which is in the first row and first column of the game card 802, is entered at the location corresponding to the ace of diamonds, which is in the first row and first column of the game card 1000. The remaining numbers and the “Free Space” in the center of the game card are mapped to the playing cards in the same manner.

Much of the following discussion indicates that a gaming machine performs certain functions and a game server or other network device performs other functions. However, in alternate implementations, these steps may be allocated differently. For example, a game server or other device in a gaming network may perform functions (e.g., mapping functions) that are described below as being performed by a gaming machine.

In this example, a gaming machine may store records with the combinations of numbers and playing cards, e.g., in program memory, RAM, or other convenient memory. During the occurrence of the bingo game as the numbers are drawn (and, for example, transmitted by a game server to participating gaming machines), the mapping chart 1010 may be used to determine the playing card of the game card 1000, if any, corresponding to the drawn number, such that the matching playing card may be marked on the game card 1000. In this way, despite that fact that the same game card 1000 may be displayed to each player at the corresponding gaming unit 20, each game card 1000 may be marked in a unique manner corresponding to the numbers of the player's underlying bingo game card 802.

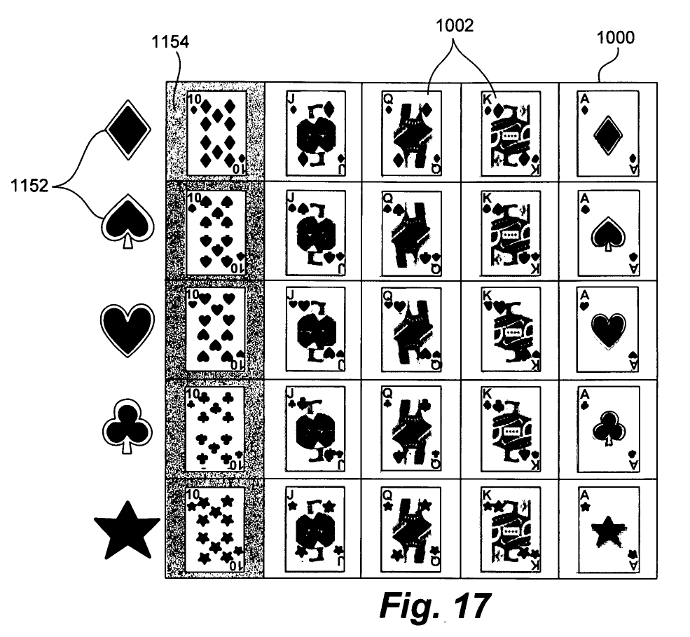

When the alternative game cards 1000 are offered to the players, the multi-player bingo game may still proceed in a similar manner as previously described. As an example, the multi-player bingo game may be configured to execute the routine 760 of FIGS. 17A and 17B of U.S. Provisional Application No. 60/503,161, entitled “Gaming Network with Multi-Player Bingo Game (Methods for Presentation of Bingo Outcomes in Gaming),” which is incorporated by reference herein for all purposes. In that example, the numbers are drawn one at a time and transmitted to the players' gaming machines for comparison to the players' game cards 802. The overall flow of the routine 760 may remain the same with modifications at various steps in the process to allow for the use of the alternate game cards 1000 and mapping chart 1010.

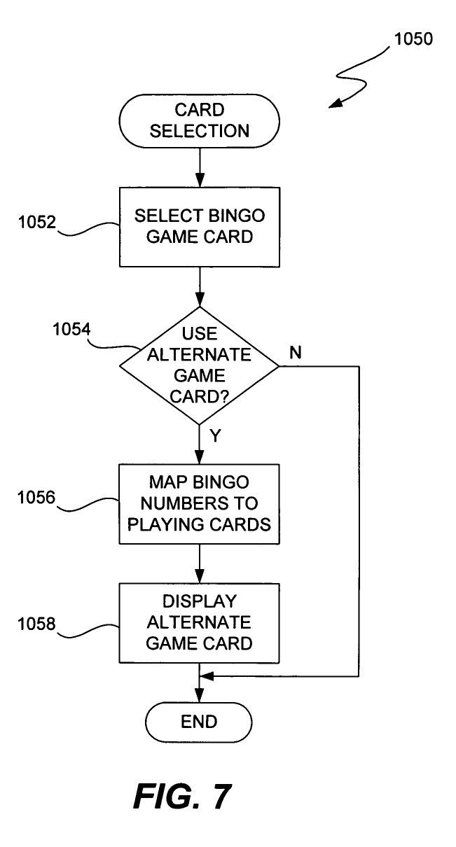

One modification may occur, for example, at blocks 702 and 708, wherein the players enroll in an occurrence of the multi-player bingo game. As previously described, the enrollment process for a player may include depositing currency or other value at a gaming machine, selecting or having the gaming machine select a bingo game card for use in the bingo game, selecting a wager amount for the occurrence of the bingo game, and touching the play button at the gaming machine to notify a network device (such as a game server) of the requested enrollment of an additional player.

Where the alternate game card 1000 is available to display the outcome of the bingo game, the enrollment process may be modified to include the game card selection routine 1050 shown in FIG. 7. When a player enrolls in an occurrence of the bingo game, control may pass to a block 1052 wherein a bingo game card is selected for use by the player. As previously described, the bingo game card may be automatically selected for the player (e.g. by the gaming machine or by a game server), or the player may be able to select another desired bingo game card to use. Once the bingo game card is selected for the player, the routine 1050 may pass to a block 1054 wherein the player may have the option of displaying and using an alternative game card, such as the game card 1000 of FIG. 5.

To inform the player of the option to display an alternate game card, the gaming machine may, for example, display a prompt at the display device, or include an appropriately labeled button or other input device, to allow the player to elect to display the alternative game card. If the player does not want to use an alternate game card as signified by the appropriate input at the gaming machine, the game card selection routine may end and the enrollment process may continue. If the player elects to display the alternate game card during the occurrence of the bingo game, control may pass to a block 1056 wherein the numbers of the bingo game card may be mapped to the playing cards on the alternate game card in the manner described above. The mapping may be performed, for example, by a game server, by the gaming machine, or by another device. Corresponding combinations of bingo numbers and playing cards (and/or bingo card areas) may be stored in memory for use during the occurrence of the bingo game. Control may then return to the enrollment process and the alternate game card 1000 may be displayed to the player at a display of a gaming machine at a block 1058.

The routine 1050 is one example of a card selection routine usable during the enrollment process for the multi-player bingo game, and other selection routines are contemplated as having use with the alternate game cards. For example, the multi-player bingo game may be configured such that all players will have a non-traditional game card such as the poker game card 1000 displayed and used during the bingo game. In such implementations, the election to use the alternate game card at block 1054 may be unnecessary. Further, the selection routine 1050 may be configured to prompt the players to elect to use an alternate game card before selecting a traditional bingo game card, with the bingo game card being selected and mapped automatically if the player elects to display the alternate game card.

Still further, instead of generating a bingo game card and then mapping the bingo game card to the symbols on the alternate game card, the process may forego having a separate bingo game card selection step and instead randomly select numbers for each of the playing cards of the alternate game card. For example, the controller may randomly select a number between 1 and 15 and assign the number to the ace of diamonds, select a second number from the remaining numbers between 1 and 15 and assign the number to the king of diamonds, and so on until all the playing cards have an assigned number. Additional methods for performing the mapping process will be apparent to those skilled in the art and are contemplated as having use with the present invention.

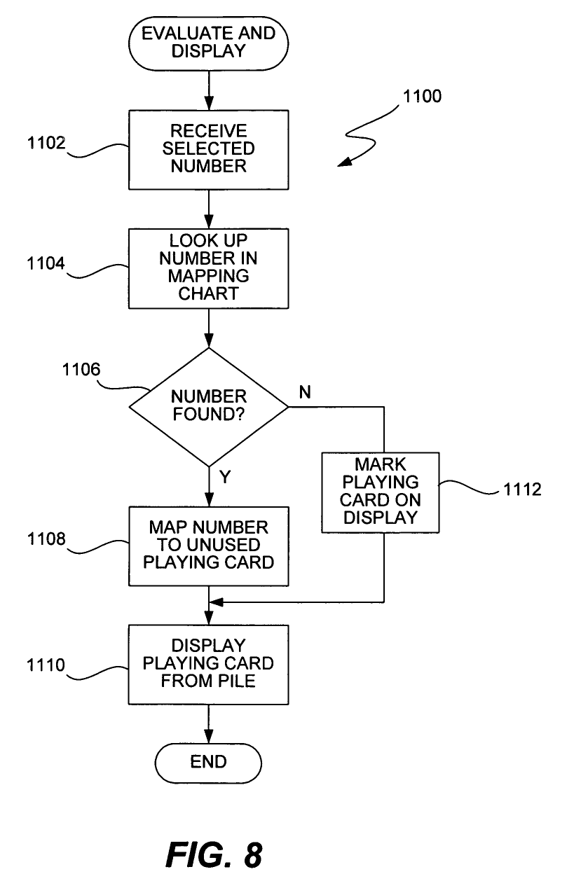

Once the players are enrolled and the bingo game cards are mapped to the alternate game cards, the routine 760 may proceed as previously described until the bingo cards are evaluated at block 720 and the outcome is displayed at block 722. FIG. 8 illustrates a combined card evaluation and outcome display routine 1100 that may be executed at a gaming machine displaying the alternate bingo card 1000. For purposes of illustration, the numbers may be drawn in the same order as shown in FIGS. 6-15 of U.S. Provisional Application No. 60/503,161 and discussed in the accompanying text. After a drawn number selected and transmitted by a game server is received at a gaming machine at a block 1102, control may pass to a block 1104 wherein the gaming machine may perform a look-up of the mapping chart 1010 stored in memory for an entry corresponding to the drawn number. If the drawn number is not found in the mapping chart at a block 1106, control may pass to a block 1108 wherein the drawn number may be mapped to one of the remaining unused playing cards from the deck.

A controller of the gaming machine may be configured with any appropriate algorithm for serially or randomly selecting one of the remaining playing cards to be matched to the drawn number for the occurrence of the bingo game. As one example, the controller may be configured to continue to match the number ranges for the columns of the traditional bingo game cards with playing cards within the corresponding suit on the alternate game cards. In the previously illustrated draw/ball drop, the first drawn number, 44, may not be found in the mapping chart of FIG. 6 because the number 44 was not found on the player's bingo game card 802. Consequently, there is no match on the bingo game card 802 and, correspondingly, on the alternate game card 1000.

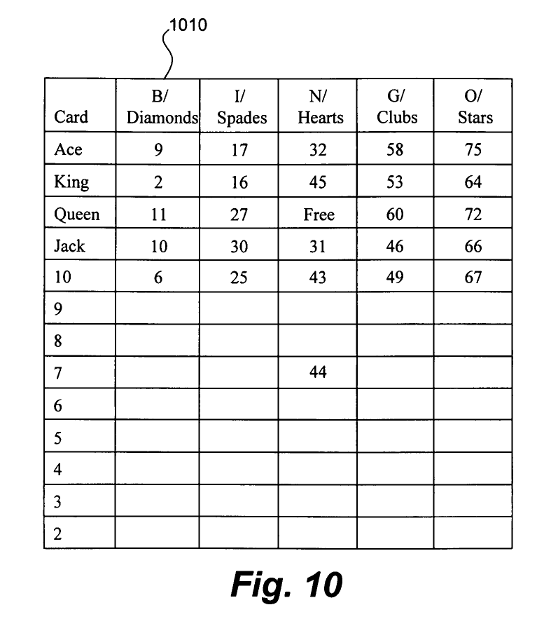

In order to enhance the game experience of the player, it may be desired to map a playing card to the drawn number in order to display the ball draw to the player in a manner consistent with the theme of the game. The number 44 is within the range from 31-45 corresponding to the “N” column of the bingo game card 802 and, consequently, the hearts column of the alternate game card 1000. The controller may be programmed to select one of the unused hearts, presently the 2 through 9 of hearts, to correspond to the number 44. In the example, the controller may randomly select the 7 of hearts from the available playing cards for association with the number 44. Once selected, the controller may update the mapping chart as shown in FIG. 10 to indicate that the 7 of hearts corresponds to the number 44 and to prevent remapping of the 7 of hearts to another number at least as long as other playing cards remain unmapped and unused.

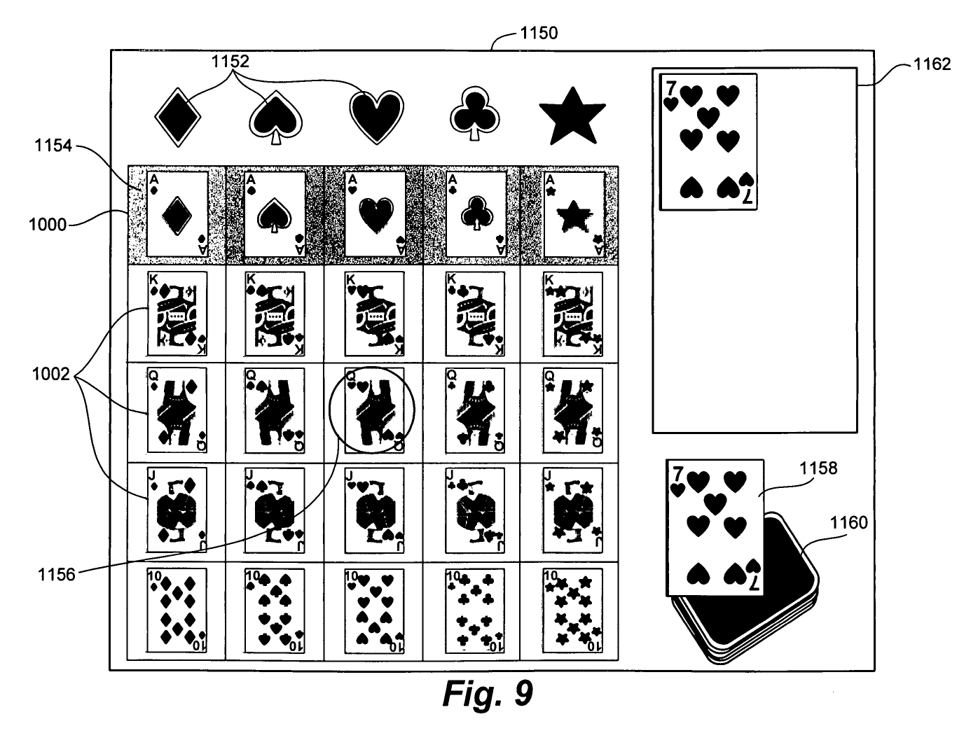

After the drawn and previously unused number 44 is mapped to the 7 of hearts, control may pass to a block 1110 wherein the display at the gaming machine may be updated to display that the 7 of hearts is been selected from the available playing cards. FIG. 9 illustrates one embodiment of an alternative game card display 1150 that may be displayed at the gaming machine for a player electing to use the alternate game card 1000. The display 1150 may illustrate the players' alternate game card 1000 with the array of playing cards 1002 having the corresponding suit symbols disposed above the columns of the array. The game-winning pattern 1154 may be highlighted on the game card 1000 by shading the appropriate locations within the array of playing cards 1002, and matched playing cards 1002 may be identified via appropriate marks 1156 displayed at the locations of the matched playing cards 1002. In the illustrated example, the queen of hearts corresponds to the free space at the center of the game card 802 of FIG. 4 and, consequently, is displayed with mark 1156 at the outset of the occurrence of the bingo game.

The display 1150 may further include displays relating to the currently drawn playing card and to the playing cards that have been drawn up to the current point in the occurrence of the bingo game. In this example, the current playing card 1158 is displayed in a manner simulating the drawing of the current playing card 1158 from the top of a deck of playing cards 1160. At the same time, the playing card may also be displayed along with previously selected playing cards in a playing card draw area 1162 similar to the game ball draw area 812 previously described. As the game proceeds, the display of the current playing card 1158 may be updated to display the playing card corresponding to the most recently selected number, while the card draw area 1162 may be updated to display the playing cards corresponding to the numbers selected up to a given point in the occurrence of the bingo game. Playing cards that correspond to “hits” on the bingo card may be displayed differently (e.g., brighter, higher contrast, larger, more colorful) from cards that are not hits.

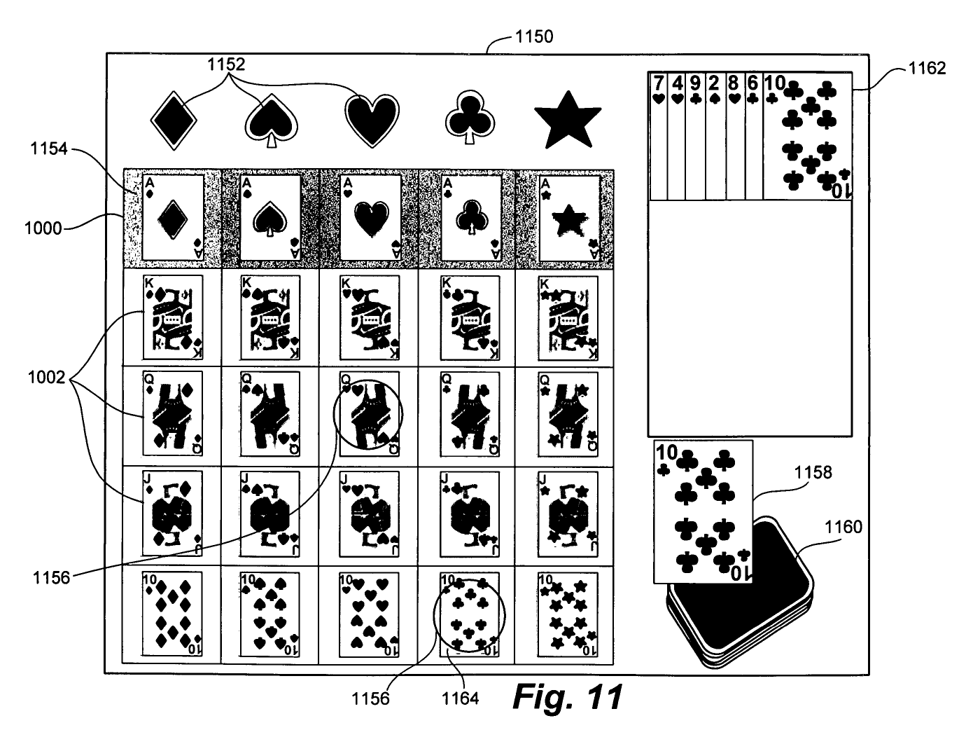

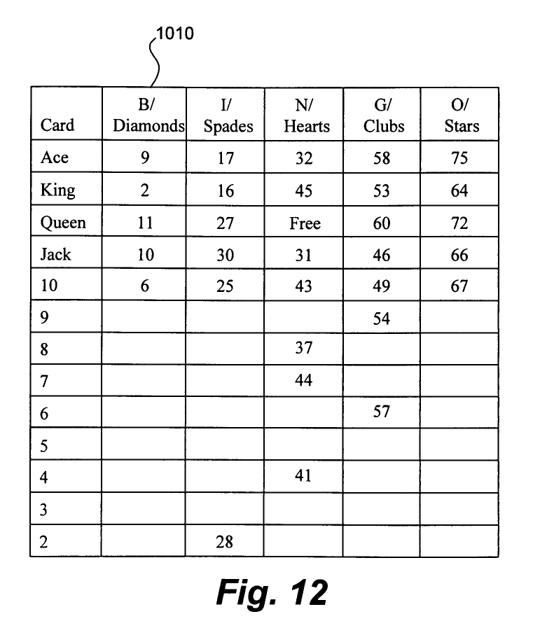

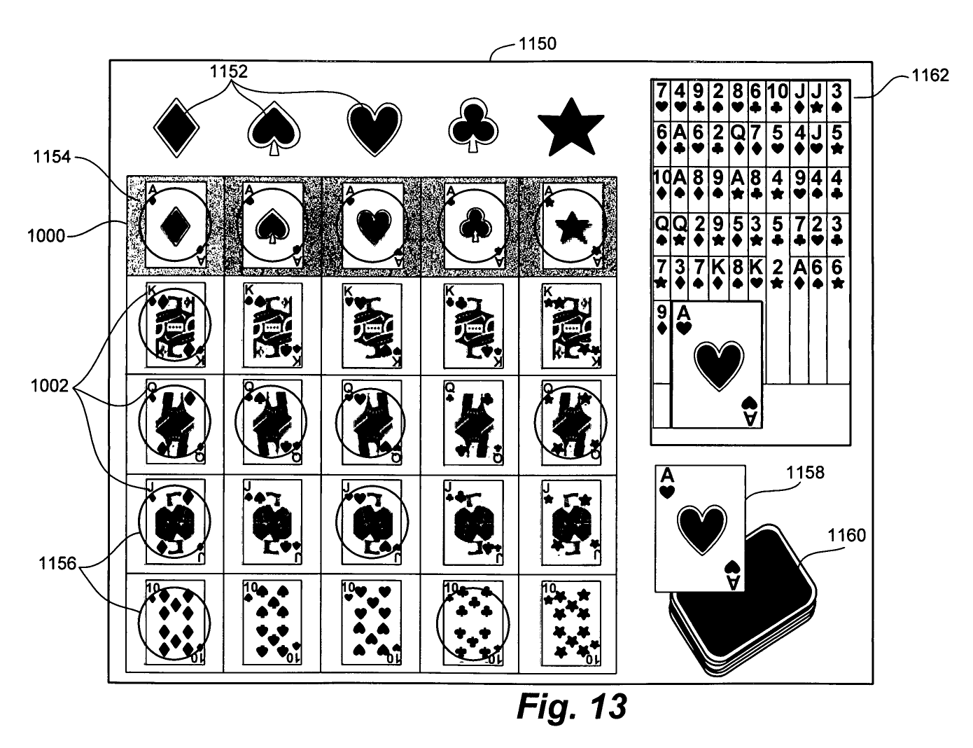

Returning to FIG. 8, if the controller 100 of a gaming machine determines that a selected number is found in the mapping chart 1110, control may pass to a block 1112 wherein the playing card 1102 corresponding to the selected number may be updated on the display 150 with a mark 1156 to indicate that the playing card 1002 has been matched. For example, referring to FIGS. 11 and 12, the playing card draw area 1162 indicates that the following playing cards have been displayed to the player at the display 1150; 7 of hearts, 4 of hearts, 9 of clubs, 2 of spades, 8 of hearts, 6 of clubs, and 10 of clubs. The mapping chart 1010 in FIG. 12 further illustrates that the first six selected numbers, 44, 41, 54, 28, 37, and 57, respectively, that were not found in the mapping chart 1010 at block 1106 of FIG. 8, were mapped to unused playing cards at block 1108, and displayed in the playing card draw area 1162.

As the numbers are mapped, the controller of the gaming machine may store records relating to the map to numbers and the corresponding playing cards. When the number 49 is received at the gaming machine at block 1102 of FIG. 8, a look up is performed for the number 49 among the stored records for the mapping chart 1010 at block 1104. The number 49 may be found at block 1106 and control may pass to the block 1112, wherein the display 1150 may be updated such that a mark 1156 is displayed at the 10 of clubs 1164 of the alternate game card 1000. Additionally, the current playing card 1158 and the card draw area 1162 are updated to display the 10 of clubs as the currently selected playing card.

As the bingo game continues and numbers are selected and transmitted to the gaming machines, the gaming machines look up the selected numbers in the mapping chart 1010 and, if a match is found, mark the corresponding playing cards 1002 on the alternate game card 1000 until one of the players matches the game winning pattern 1154. As illustrated in FIGS. 13 and 14, 52 numbers were selected until the player matched the game-ending pattern 1154 on the alternate game card 1000. At this point, the player may win the occurrence of the bingo game or may be required to daub to accept the bingo game win in a similar manner as previously described. As the occurrence of the game progressed, numbers not previously found in the mapping chart 1010 were mapped to the unused playing cards, with records for numbers and corresponding playing cards being generated and stored as reflected in the mapping chart 1010. During the course of the occurrence of the bingo game, the unused playing cards in a given suit may be mapped to selected numbers such that there are no remaining unused playing cards for that suit.

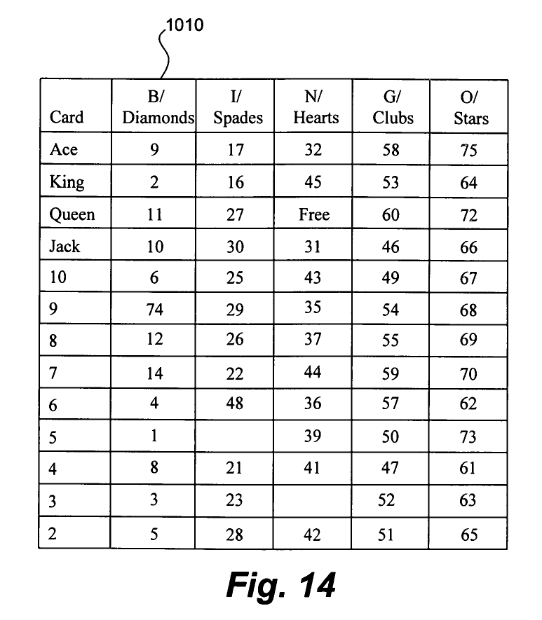

In the illustrated example, once numbers were matched to each of the unused cards in the clubs and stars suits, at block 1108 of FIG. 8 the gaming machines may be configured to randomly select one of the remaining unused cards of a different suit in order to complete the draw such that, in most occurrences, it may not be necessary to reuse playing cards of create additional ranks of playing cards to complete the draw. For example, as shown in FIG. 14, by the time the number 48 was selected, selected numbers from the range of 46 through 60 may have been mapped to the 2 through 9 of clubs such that no clubs were available to map to the number 48. With no clubs available, the controller of the gaming machine may have been configured to select one of the remaining unused playing cards from the other suits to which to map the number 48, in this case the 6 of spades. Similarly, upon finding no unused stars when the number 74 was selected, the gaming machine may have randomly selected to 9 of diamonds to which to map the number 74.

In the event that all of the available playing cards are mapped to selected numbers, the gaming machines may be configured to reuse playing cards, to use additional non traditional ranks of playing cards to complete the draw, or to display other indicia indicative of the selection of additional numbers that did not match numbers on the players bingo card to which the alternate game card 1000 is mapped. After the occurrence of the bingo game is complete, and the same player or another player enrolls in a subsequent occurrence of the bingo game, the mapping chart 1010 may be reset with the numbers 2 through 9 of each suit available for mapping to selected numbers and, if necessary, the 10 through ace of each suit may be remapped to the numbers of the players bingo game card if a different bingo game card is selected for the subsequent occurrence of the bingo game.

In the previous example, the numbers on the bingo game card 802 were mapped to the playing cards on the alternate game card 1000 such as there is 1 to 1 correspondence between the columns of the bingo game card 802 and the playing card suits of the alternate game card 1000. However, those skilled in the art will understand that alternate mapping strategies may be implemented for matching the numbers of the bingo game card 802 to the playing cards of the alternate game card 1000.

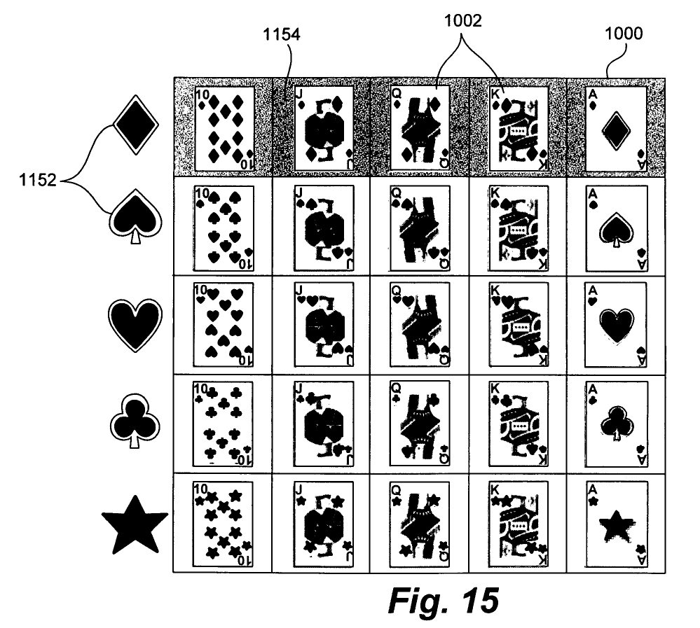

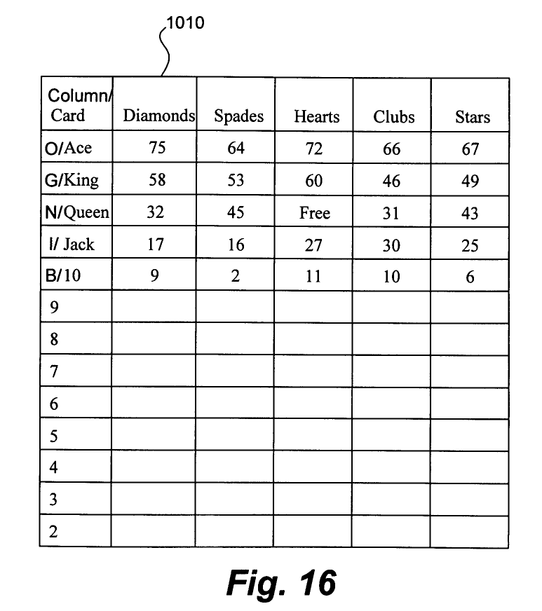

For example, FIGS. 15 and 16 illustrate a mapping strategy wherein the columns of the bingo game card 802 may each be mapped to a corresponding rank of the playing cards on the alternate game card 1000. In this example, the numbers in the “B” column of the bingo game card 802 may be mapped to corresponding playing cards 1002 representing the 10 of each suit. Similarly, the “I,” “N,” “G,” and “O” columns may be mapped to jacks, queens, kings, and aces, respectively, such that each row of the alternate game card 1000 displays the cards for a royal flush of the corresponding suit with the cards in ascending order from 10 through ace, and with each column having five of a kind of the corresponding card rank. This mapping strategy is further illustrated in the mapping chart 1010 of FIG. 16, which may be stored, for example, by the gaming machine during the occurrence of the bingo game.

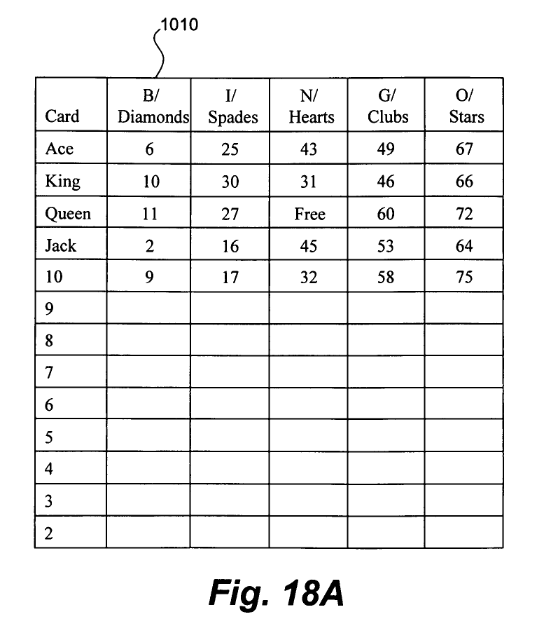

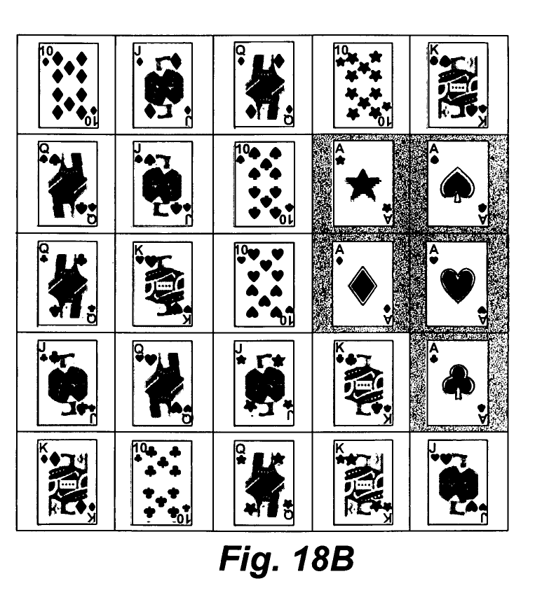

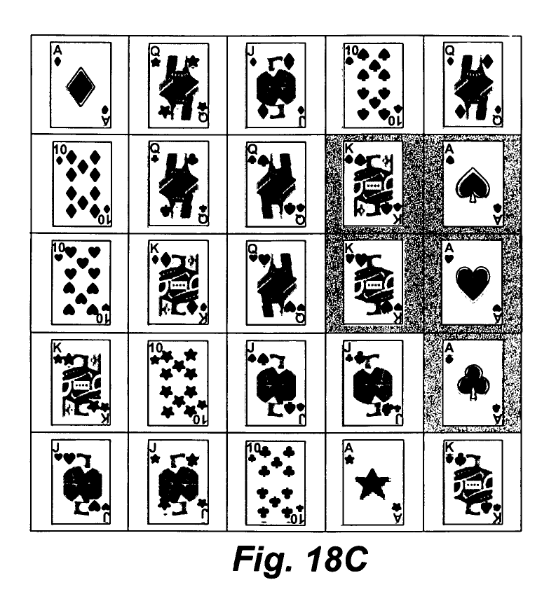

In a further alternate mapping strategy illustrated in FIGS. 17 and 18A, the numbers in a particular column may be mapped to the 10 through ace of a particular suit, but with the playing cards of the alternate game card 1000 being arranged such that each row corresponds to a royal flush for a particular suit. Mapped in this manner, the rows and columns of numbers of the bingo game card 802 may be transposed during the mapping process such that each column of the bingo game card 802 may map to a corresponding row of the alternate game card 1000.

For example, in the game card 802 of FIG. 4, the 9 in the upper left hand corner of the bingo card 802 maps to the 10 of diamonds in the upper left hand corner of the alternate game card 1000, while the 6 in the lower left corner of the bingo card 802 maps to the ace of diamonds in the upper right hand corner of the alternate game card 1000, and the number 75 in the upper right hand corner of the bingo game card 802 maps to the 10 of stars in the lower left hand corner of the alternate card 1000. The remaining numbers are similarly transposed during the mapping of the bingo game card 802 to the alternate game card 1000 as illustrated in FIG. 18A. With the transposition of the rows and columns of the bingo game card 802 in this mapping strategy, it may also be desired to transpose the game winning pattern 840 consisting of the five numbers in the top row of the bingo game card 802 into the game winning pattern 1154 on the alternate game card 1000 consisting of five of a kind of 10's in the first column of the alternate game card 1000.

FIGS. 18B and 18C illustrate other embodiments of alternate game card 1000, in which game-winning pattern 1800 is not a complete row, column or diagonal. Game-winning pattern 1800 corresponds with a poker hand of 5 aces in FIG. 18B. Game-winning pattern 1800 corresponds with a poker hand of a full house, aces high, in FIG. 18C. Unlike some other embodiments, the playing cards in these embodiments of alternate game card 1000 are not organized such that rows or columns of the card correspond with a particular card or suit. Similarly, the game-winning pattern does not correspond to a completed row, column or diagonal.

In some implementations, all players of a particular game would have a bingo card, e.g., as shown in either 18B or 18C. The bingo numbers corresponding to each area/playing card symbol would preferably be different, as noted above, and all players would be playing for the same game-winning pattern and hand of cards. In alternative implementations, all players play for the same game-winning pattern, but the game-winning pattern may correspond to a plurality of card hands on various bingo cards. For example, one player of a game could have a bingo card as shown in FIG. 18B and another player in the same game could have a bingo card as shown in FIG. 18C. Each player is playing for the same game-winning pattern and has the same chance of winning. However, the potentially game-winning hand of cards is not the same on each bingo card.

While several alternate mapping strategies are described and illustrated herein, those skilled in the art will understand that other mapping strategies may be used to match the numbers of the bingo game card 802 to playing cards of the alternate game card 1000 or to other configurations of alternate game cards.

In the previously described embodiment, each occurrence of the bingo game may include some players using bingo game cards 802, while the remaining players may use the alternate game cards 1000. However, the gaming machines and the multi-player bingo game (i.e., a game provided by a game server) may be configured such that all of the game cards used in a given occurrence of the multi-player bingo game may be either the standard bingo game card 802 or the alternate game cards 1000. In one embodiment, the multi-player bingo game may be configured such that players electing to display the alternate game card 1000 may be grouped together separately from players electing to use the standard bingo card 802 at the time the player elects to use the alternate game card 1000 at blocks 1052, 1054 of FIG. 7.

When the first player enrolls in an occurrence of the multi-player bingo game at block 702 of FIG. 17A and elects to use either the bingo game card 802 or the alternate game card 1000, additional players enrolling at block 708 and electing to use the same game card 802, 1000 as the first enrolling player may be added for the same occurrence of the game until the enrollment timer expires at block 710. At the same time, additional players enrolling at block 708 an electing to use the game card 802, 1000 not selected by the first enrolling player may be placed in a different occurrence of the multi-player bingo game with other later enrolling players electing to use the other game card 802, 1000 until the expiration of the enrollment timer for the other occurrence of the multi-player bingo game. As a further alternative, the gaming units 20 may segregated into groups offering the multi-player bingo game and displaying either the bingo game card 802 or the alternate game card 1000, and not allowing players to elect between the game cards 802, 1000.

In further alternative embodiments, the alternative game cards 1000 may be generated without the necessity of mapping the alternate game cards 1000 to underlying bingo game cards 802. For example, each occurrence of the multi-player bingo game may use a random draw of numbers from the range of 1 through 75, but with numbers from that range being mapped directly to the playing cards 1002 of the alternate game card 1000 instead of first selecting a bingo game card 802 for the player for the occurrence of the game. In one implementation, the range of numbers 1 through 75 may be subdivided into ranges corresponding to suits or ranks of cards in a similar manner as the numbers are grouped for the columns of the traditional bingo card 802, with numbers within the groups being randomly selected to map to the playing cards on the alternate game card 1000 within the corresponding suit or rank. Alternatively, the selection of numbers from within the range of 1 through 75 may be completely random such that any number from the range may be mapped to any of the playing cards 1002 on the alternate game card 1000 for a given occurrence of the game.

It will further be understood that for implementations of the multi-player game that did not use an underlying bingo game card 802 for mapping to the alternate game card 1000, the random number draw or other random selection mechanism may be appropriately sized to correspond to the number of individual playing cards that may be displayed during the course of the multi-player game using the alternate game card 1000. Still further, the alternate game card 1000 may be configured as desired for the implementation of the multi-player game. For example, the alternate game card 1000 may consist of an array of four rows by five columns, with each row corresponding to one of the suits of a traditional deck of playing cards, and with the five playing cards in each row being randomly selected from the thirteen available playing cards within each suit. Of course, other configurations of the alternate game card 1000 will be apparent to those skilled in the art as having use with the multi-player game according to the present invention.

The bingo cards illustrated above further show the same game-winning pattern 1154 used on the alternate game card 1000 as the game-winning pattern 840 used on the bingo game card 802. However, the game winning patterns used on the alternate game card 1000 may be varied as desired to further enhance a poker theme for the multi-player game. For example, the multi-player game may be configured such that predetermined traditional poker hands may be used as the game winning patterns for the multi-player game. Consequently, in some implementations any matched pattern constituting four of a kind, five of a kind, a royal flush and the like may constitute a game-winning pattern on the alternate game card 1000.

If desired, particularly in implementations where an occurrence of the game may include some players using the alternate game card 1000 and other players using traditional bingo cards 802, the poker hands constituting game-winning patterns may be selected such that the probability of matching the game-winning pattern on the alternate game card 1000 is approximately equal to the probability of matching the game-winning pattern on the traditional bingo game card 802. For games utilizing only the alternate game card 1000, the game-winning pattern may be varied between occurrences of the game and be randomly determined, or otherwise determined in order to implement a desired game play strategy for the multi-player game.

Games utilizing the alternate game card 1000 may also offer interim awards for matching predetermined interim patterns in a similar manner as discussed above. As with the game winning patterns, players may receive interim pattern awards for matching the same patterns as players playing the bingo cards 802. Alternatively, as with the game-winning patterns, the interim patterns for the alternate game card 1000 may be selected to correspond to predetermined poker hands having approximately the same probability of being matched during the occurrence of the game as corresponding interim patterns for the bingo game card 802. Still further, the interim patterns for the alternate game card 1000 may be selected independently of the interim patterns for the bingo game cards 802 to match predetermined poker hands that result in gaming awards to achieve a desired payout rate for the multi-player game.

Each area of the bingo card does not necessarily map to an unique card. In some implementations, for example, 2 or more spots can map to the same card. Thus, the player's bingo card may have, e.g., 5 spots that could map to the King of diamonds. In some such implementations, the player will not know which spot on the bingo card (in this example, which King of diamonds) maps to the drawn card until he or she daubs. Such implementations further increase player anticipation and excitement. In other implementations having non-unique card mappings, the player may choose one spot among 2 or more spots on the bingo card corresponding to the drawn card. For example, the player may select the spot by touching a corresponding portion of a display screen. In yet other implementations having non-unique card mappings, the spot on the bingo card is chosen as soon as the card is drawn.

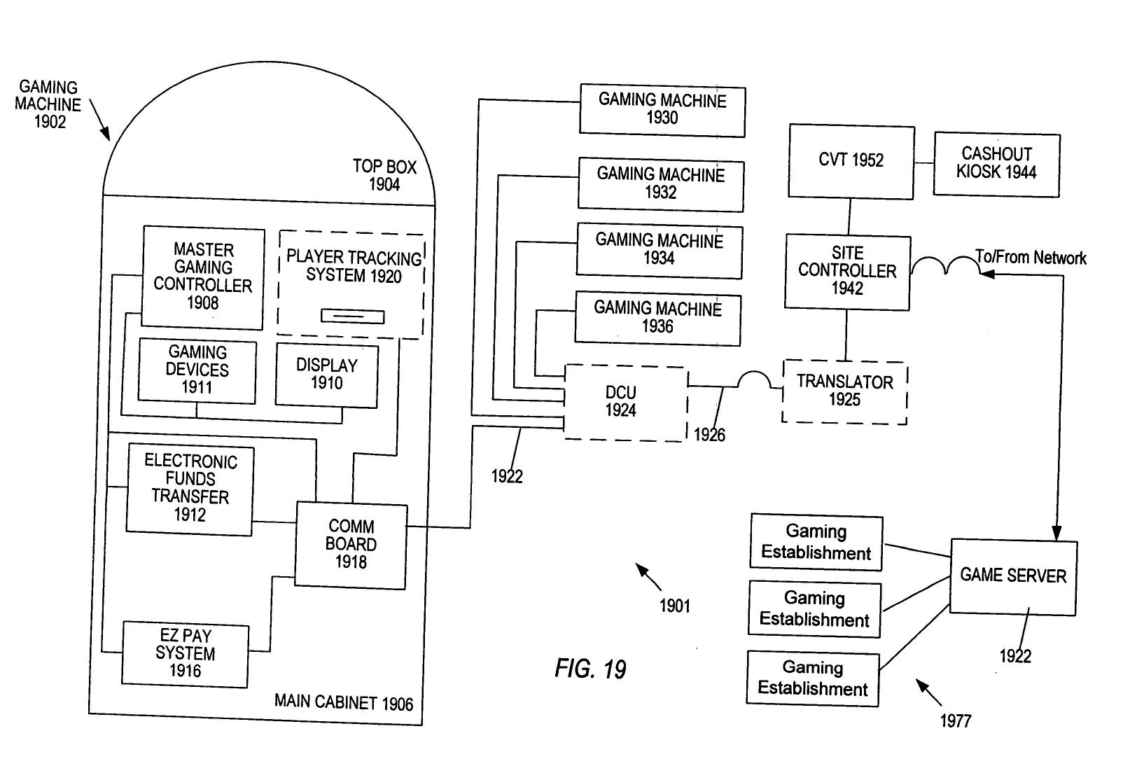

One example of a gaming machine network that may be used to implement methods of the invention is depicted in FIG. 19. Gaming establishment 1901 could be any sort of gaming establishment, such as a casino, a card room, an airport, a store, etc. However, the methods and devices of the present invention are intended for gaming networks (which may be in multiple gaming establishments) in which there is a sufficient number of Class II gaming machines for bingo play. In this example, gaming network 1977 includes more than one gaming establishment, all of which are networked to game server 1922.

Here, gaming machine 1902, and the other gaming machines 1930, 1932, 1934, and 1936, include a main cabinet 1906 and a top box 1904. The main cabinet 1906 houses the main gaming elements and can also house peripheral systems, such as those that utilize dedicated gaming networks. The top box 1904 may also be used to house these peripheral systems.

The master gaming controller 1908 controls the game play on the gaming machine 1902 according to instructions and/or game data from game server 1922 and receives or sends data to various input/output devices 1911 on the gaming machine 1902. Details of exemplary systems for using a game server to control a network of gaming machines to implement bingo games are described in U.S. patent application Ser. No. 60/503,161 (client docket number P-888), filed Sep. 15, 2003 and entitled “Gaming Network with Multi-Player Bingo Game.” This application is hereby incorporated by reference for all purposes. The master gaming controller 1908 may also communicate with a display 1910.

A particular gaming entity may desire to provide network gaming services that provide some operational advantage. Thus, dedicated networks may connect gaming machines to host servers that track the performance of gaming machines under the control of the entity, such as for accounting management, electronic fund transfers (EFTs), cashless ticketing, such as EZPay™, marketing management, and data tracking, such as player tracking. Therefore, master gaming controller 1908 may also communicate with EFT system 1912, EZPay™ system 1916 (a proprietary cashless ticketing system of the present assignee), and player tracking system 1920. The systems of the gaming machine 1902 communicate the data onto the network 1922 via a communication board 1918.

It will be appreciated by those of skill in the art that the present invention could be implemented on a network with more or fewer elements than are depicted in FIG. 19. For example, player tracking system 1920 is not a necessary feature of the present invention. However, player tracking programs may help to sustain a game player's interest in additional game play during a visit to a gaming establishment and may entice a player to visit a gaming establishment to partake in various gaming activities. Player tracking programs provide rewards to players that typically correspond to the player's level of patronage (e.g., to the player's playing frequency and/or total amount of game plays at a given casino). Player tracking rewards may be free meals, free lodging and/or free entertainment.

Moreover, DCU 1924 and translator 1925 are not required for all gaming establishments 1901. However, due to the sensitive nature of much of the information on a gaming network (e.g., electronic fund transfers and player tracking data) the manufacturer of a host system usually employs a particular networking language having proprietary protocols. For instance, 10-20 different companies produce player tracking host systems where each host system may use different protocols. These proprietary protocols are usually considered highly confidential and not released publicly.

Further, in the gaming industry, gaming machines are made by many different manufacturers. The communication protocols on the gaming machine are typically hard-wired into the gaming machine and each gaming machine manufacturer may utilize a different proprietary communication protocol. A gaming machine manufacturer may also produce host systems, in which case their gaming machine are compatible with their own host systems. However, in a heterogeneous gaming environment, gaming machines from different manufacturers, each with its own communication protocol, may be connected to host systems from other manufacturers, each with another communication protocol. Therefore, communication compatibility issues regarding the protocols used by the gaming machines in the system and protocols used by the host systems must be considered.

A network device that links a gaming establishment with another gaming establishment and/or a central system will sometimes be referred to herein as a “site controller.” Here, site controller 1942 provides this function for gaming establishment 1901. Site controller 1942 is connected to a central system and/or other gaming establishments via one or more networks, which may be public or private networks. Among other things, site controller 1942 communicates with game server 1922 to obtain game data, such as ball drop data, bingo card data, etc.

In the present illustration, gaming machines 1902, 1930, 1932, 1934 and 1936 are connected to a dedicated gaming network 1922. In general, the DCU 1924 functions as an intermediary between the different gaming machines on the network 1922 and the site controller 1942. In general, the DCU 1924 receives data transmitted from the gaming machines and sends the data to the site controller 1942 over a transmission path 1926. In some instances, when the hardware interface used by the gaming machine is not compatible with site controller 1942, a translator 1925 may be used to convert serial data from the DCU 1924 to a format accepted by site controller 1942. The translator may provide this conversion service to a plurality of DCUs.

Further, in some dedicated gaming networks, the DCU 1924 can receive data transmitted from site controller 1942 for communication to the gaming machines on the gaming network. The received data may be, for example, communicated synchronously to the gaming machines on the gaming network.

Here, CVT 1952 provides cashless and cashout gaming services to the gaming machines in gaming establishment 1901. Broadly speaking, CVT 1952 authorizes and validates cashless gaming machine instruments (also referred to herein as “tickets” or “vouchers”), including but not limited to tickets for causing a gaming machine to display a game result and cashout tickets. Moreover, CVT 1952 authorizes the exchange of a cashout ticket for cash. These processes will be described in detail below. In one example, when a player attempts to redeem a cashout ticket for cash at cashout kiosk 1944, cash out kiosk 1944 reads validation data from the cashout ticket and transmits the validation data to CVT 1952 for validation. The tickets may be printed by gaming machines, by cashout kiosk 1944, by a stand-alone printer, by CVT 1952, etc. Some gaming establishments will not have a cashout kiosk 1944. Instead, a cashout ticket could be redeemed for cash by a cashier (e.g. of a convenience store), by a gaming machine or by a specially configured CVT.

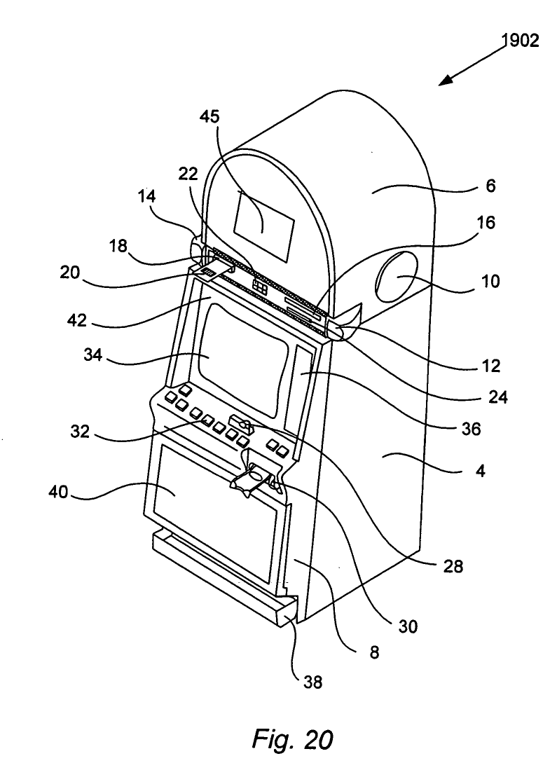

Turning to FIG. 20, more details of gaming machine 1902 are described. Machine 1902 includes a main cabinet 4, which generally surrounds the machine interior (not shown) and is viewable by users. The main cabinet 4 includes a main door 8 on the front of the machine, which opens to provide access to the interior of the machine. Attached to the main door are player-input switches or buttons 32, a coin acceptor 28, and a bill validator 30, a coin tray 38, and a belly glass 40. Viewable through the main door is a video display monitor 34 and an information panel 36. The display monitor 34 will typically be a cathode ray tube, high resolution flat-panel LCD, or other conventional electronically controlled video monitor. The information panel 36 may be a back-lit, silk screened glass panel with lettering to indicate general game information including, for example, the number of coins played. The bill validator 30, player-input switches 32, video display monitor 34, and information panel are devices used to play a game on the game machine 1902. The devices are controlled by circuitry housed inside the main cabinet 4 of the machine 1902.

The gaming machine 1902 includes a top box 6, which sits on top of the main cabinet 4. The top box 6 houses a number of devices, which may be used to add features to a game being played on the gaming machine 1902, including speakers 10, 12, 14, a ticket printer 18 which may print bar-coded tickets 20 used as cashless instruments. The player tracking unit mounted within the top box 6 includes a key pad 22 for entering player tracking information, a florescent display 16 for displaying player tracking information, a card reader 24 for entering a magnetic striped card containing player tracking information, a microphone 43 for inputting voice data, a speaker 42 for projecting sounds and a light panel 44 for display various light patterns used to convey gaming information. In other embodiments, the player tracking unit and associated player tracking interface devices, such as 16, 22, 24, 42, 43 and 44, may be mounted within the main cabinet 4 of the gaming machine, on top of the gaming machine, or on the side of the main cabinet of the gaming machine.

Understand that gaming machine 1902 is but one example from a wide range of gaming machine designs on which the present invention may be implemented. For example, not all suitable gaming machines have top boxes or player tracking features. Further, some gaming machines have two or more game displays—mechanical and/or video. Some gaming machines are designed for bar tables and have displays that face upwards. Still further, some machines may be designed entirely for cashless systems. Such machines may not include such features as bill validators, coin acceptors and coin trays. Instead, they may have only ticket readers, card readers and ticket dispensers. Those of skill in the art will understand that the present can be deployed on most gaming machines now available or hereafter developed. Moreover, some aspects of the invention may be implemented on devices which lack some of the features of the gaming machines described herein, e.g., workstation, desktop computer, a portable computing device such as a personal digital assistant or similar handheld device, a cellular telephone, etc. U.S. patent application Ser. No. 09/967,326, filed Sep. 28, 2001 and entitled “Wireless Game Player,” is hereby incorporated by reference for all purposes.

Returning to the example of FIG. 20, when a user wishes to play the gaming machine 1902, he or she inserts cash through the coin acceptor 28 or bill validator 30. In addition, the player may use a cashless instrument of some type to register credits on the gaming machine 1902. For example, the bill validator 30 may accept a printed ticket voucher, including 20, as an indicium of credit. As another example, the card reader 24 may accept a debit card or a smart card containing cash or credit information that may be used to register credits on the gaming machine.

During the course of a game, a player may be required to make a number of decisions. For example, a player may vary his or her wager on a particular game, select a prize for a particular game, or make game decisions regarding gaming criteria that affect the outcome of a particular game (e.g., which cards to hold). The player may make these choices using the player-input switches 32, the video display screen 34 or using some other hardware and/or software that enables a player to input information into the gaming machine (e.g. a GUI displayed on display 16).

During certain game functions and events, the gaming machine 1902 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 1902, from lights behind the belly glass 40 or the light panel on the player tracking unit 44.

After the player has completed a game, the player may receive game tokens from the coin tray 38 or the ticket 20 from the printer 18, which may be used for further games or to redeem a prize. Further, the player may receive a ticket 20 for food, merchandise, or games from the printer 18. The type of ticket 20 may be related to past game playing recorded by the player tracking software within the gaming machine 1902. In some embodiments, these tickets may be used by a game player to obtain game services.

IGT gaming machines are implemented with special features and/or additional circuitry that differentiate them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. As anyone who has used a PC, knows, PCs are not state machines and a majority of data is usually lost when a malfunction occurs. This requirement affects the software and hardware design on a gaming machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator of a gaming machine from manipulating hardware and software in a manner that gives them an unfair and some cases an illegal advantage. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

A watchdog timer is normally used in IGT gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits contain a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.

IGT gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modem general-purpose computers include voltage monitoring circuitry, these types of circuits only report voltage status to the operating software. Out of tolerance voltages can cause software malfunction, creating a potential uncontrolled condition in the gaming computer. Gaming machines of the present assignee typically have power supplies with tighter voltage margins than that required by the operating circuitry. In addition, the voltage monitoring circuitry implemented in IGT gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for IGT slot machine game software is to use a state machine. Each function of the game (bet, play, result, etc.) is defined as a state. When a game moves from one state to another, critical data regarding the game software is stored in a custom non-volatile memory subsystem. In addition, game history information regarding previous games played, amounts wagered, and so forth also should be stored in a non-volatile memory device. This feature allows the game to recover operation to the current state of play in the event of a malfunction, loss of power, etc. This is critical to ensure the player's wager and credits are preserved. Typically, battery backed RAM devices are used to preserve this critical data. These memory devices are not used in typical general-purpose computers.

IGT gaming computers normally contain additional interfaces, including serial interfaces, to connect to specific subsystems internal and external to the slot machine. As noted above, some preferred embodiments of the present invention include parallel, digital interfaces for high-speed data transfer. However, even the serial devices may have electrical interface requirements that differ from the “standard” EIA RS232 serial interfaces provided by general-purpose computers. These interfaces may include EIA RS485, EIA RS422, Fiber Optic Serial, Optically Coupled Serial Interfaces, current loop style serial interfaces, etc. In addition, to conserve serial interfaces internally in the slot machine, serial devices may be connected in a shared, daisy-chain fashion where multiple peripheral devices are connected to a single serial channel.

IGT Gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into an IGT gaming machine by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices are preferably included in an IGT gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the trusted memory device contents in a separate third party verification device. Once the trusted memory device is verified as authentic, and based on the approval of the verification algorithms contained in the trusted device, the gaming machine is allowed to verify the authenticity of additional code and data that may be located in the gaming computer assembly, such as code and data stored on hard disk drives.

Mass storage devices used in a general-purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, IGT gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

Gaming machines used for Class III games generally include software and/or hardware for generating random numbers. However, gaming machines used for Class II games may or may not have RNG capabilities. In some machines used for Class II games, RNG capability may be disabled.

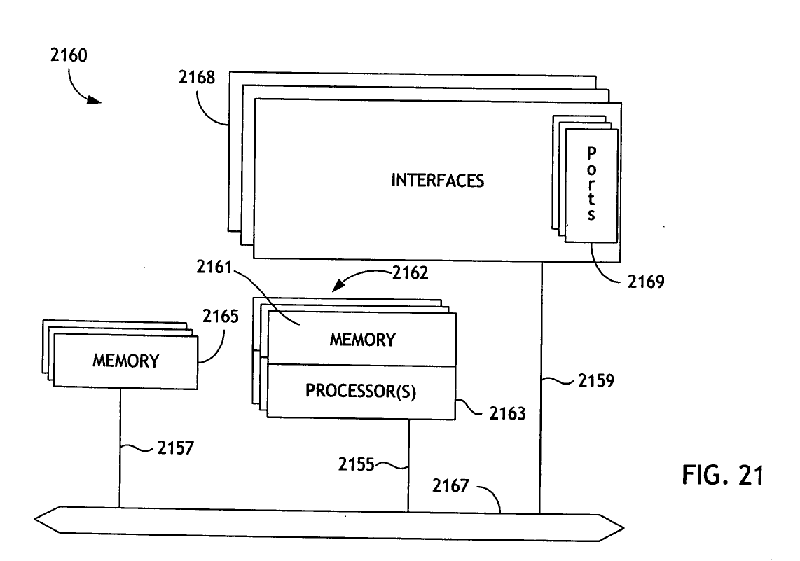

FIG. 21 illustrates an example of a network device that may be configured as a game server for implementing some methods of the present invention. Network device 2160 includes a master central processing unit (CPU) 2162, interfaces 2168, and a bus 2167 (e.g., a PCI bus). Generally, interfaces 2168 include ports 2169 appropriate for communication with the appropriate media. In some embodiments, one or more of interfaces 2168 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 2168 control such communications-intensive tasks as media control and management. By providing separate processors for the communications-intensive tasks, interfaces 2168 allow the master microprocessor 2162 efficiently to perform other functions such as routing computations, network diagnostics, security functions, etc.

The interfaces 2168 are typically provided as interface cards (sometimes referred to as “linecards”). Generally, interfaces 2168 control the sending and receiving of data packets over the network and sometimes support other peripherals used with the network device 2160. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 2162 may be responsible for implementing specific functions associated with the functions of a desired network device. According to some embodiments, CPU 2162 accomplishes all these functions under the control of software including an operating system and any appropriate applications software.

CPU 2162 may include one or more processors 2163 such as a processor from the Motorola family of microprocessors or the MIPS family of microprocessors. In an alternative embodiment, processor 2163 is specially designed hardware for controlling the operations of network device 2160. In a specific embodiment, a memory 2161 (such as non-volatile RAM and/or ROM) also forms part of CPU 2162. However, there are many different ways in which memory could be coupled to the system. Memory block 2161 may be used for a variety of purposes such as, for example, caching and/or storing data, programming instructions, etc.

Regardless of network device's configuration, it may employ one or more memories or memory modules (such as, for example, memory block 2165) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 21 illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 21) or switch fabric based (such as a cross-bar).

The above-described devices and materials will be familiar to those of skill in the computer hardware and software arts. Although many of the components and processes are described above in the singular for convenience, it will be appreciated by one of skill in the art that multiple components and repeated processes can also be used to practice the techniques of the present invention.

Although the foregoing invention has been described in some detail for purposes of clarity of understanding, it will be apparent that certain changes and modifications may be practiced within the scope of the appended claims. For example, alternative implementations provide players the option of having multiple bingo cards for a game.

1. A gaming network for providing a wagering game, the gaming network comprising:
at least one game server; and
a plurality of gaming machines configured to control an input of cash or indicia of credit for wagers for a wagering game and to control an output of cash or indicia of credit, the game server and the plurality of gaming machines further configured to provide respective aspects of the wagering game comprising:
a plurality of non-bingo symbols;
a set of bingo numbers provided for a player from a plurality of bingo numbers;
an association of each of the bingo numbers to one of the non-bingo symbols; and
a random draw of the bingo numbers, wherein if a drawn bingo number is part of the set, the non-bingo symbol associated with the drawn bingo number is marked visually or displayed visually to the player; wherein the player is provided an award if the player is first from a plurality of players playing the wagering game against the player to accumulate a designated pattern of the visually marked non-bingo symbols.

2. The gaming network of claim 1, wherein the non-bingo symbols are playing card symbols.

3. The gaming network of claim 2, wherein the designated pattern of the visually marked playing card symbols is selected from the group consisting of: four of a kind, five of a kind, two pairs, a full house, a straight, a flush, a straight flush and a royal flush.

4. The gaming network of claim 2, wherein the playing card symbols are marked visually in an array, and wherein the designated pattern includes a completed row, column or diagonal line of the array.

5. The gaming network of claim 2, wherein the playing card symbols are marked visually in an array, and wherein the designated pattern does not include a completed row, column or diagonal line of the array.

6. The gaming network of claim 1, wherein the gaming network includes a wide-area network.

7. The gaming network of claim 1, wherein the set of values is associated with a predetermined set of playing card symbols from the plurality of playing card symbols.

8. The gaming network of claim 7, wherein the set of playing card symbols includes ten, jack, queen, king and ace symbols.

9. The gaming network of claim 2, wherein the plurality of playing card symbols are divided into five suits.

10. The gaming network of claim 9, wherein the suits include diamonds, hearts, spades, clubs and a fifth suit.

11. The gaming network of claim 9, wherein the bingo numbers are alphanumeric and wherein each of the bingo numbers is associated with one of a plurality of playing card suits.

12. The gaming network of claim 11, wherein the associations are varied randomly.

13. The gaming network of claim 11, wherein the associations are fixed.

14. The gaming network of claim 1, wherein the wagering game further comprises an option provided to the player to play the game using and displaying the set of bingo numbers or the playing card symbols associated with the set of bingo numbers.

15. The gaming network of claim 2, wherein the designated pattern of playing card symbols is also a playing hand of poker.

16. A gaming network for providing a wagering game, the gaming network comprising:
at least one game server; and
a plurality of gaming machines configured to control an input of cash or indicia of credit for wagers for a wagering game and to control an output of cash or indicia of credit, the game server and the plurality of gaming machines further configured to provide respective aspects of the wagering game, comprising:
a plurality of playing card symbols divided into a plurality of suits;
a set of alphanumeric values provided for a player from a plurality of the alphanumeric values;
an association of each of the bingo values to one of the playing card symbols, wherein values having like letters are associated with card symbols of a same suit; and
a random draw of the values, wherein if a drawn value is part of the set, the playing card symbol associated with the drawn symbol is marked visually or visually displayed to the player; wherein the player is provided an award if the player is first from a plurality of players against the player to accumulate a designated combination of the visually marked playing card symbols.

17. The gaming network of claim 16, wherein the cards are divided into five suits and the letters of the alphanumeric values include the letters, B, I, N, G and O.

18. The gaming network of claim 16, wherein the designated combination of playing card symbols includes a card from each suit.

19. The gaming network of claim 16, wherein the designated combination of playing card symbols includes cards from the same suit.

20. The gaming network of claim 16, comprising a plurality of gaming devices and a game server for controlling, in part, the plurality of gaming devices to provide the wagering game.

21. The gaming network of claim 16, wherein at least some elements of the gaming network are in communication via the Internet.

22. The gaming network of claim 16, wherein the set of alphanumeric values is associated with a fixed set of playing card symbols from the plurality of playing card symbols.

23. The gaming network of claim 22, wherein the set of playing card symbols includes only tens, jacks, queens, kings and aces.

24. A method of providing a wagering game, comprising:
(a) choosing an amount of playing card symbols from which to make at least one winning hand of playing card symbols, the symbols separated into a plurality of suits;
(b) generating a like amount of alphanumeric values from a plurality of the values;
(c) forming a player set that includes each generated alphanumeric value, wherein each value has its respective letter associated with one of the suits of the playing cards and its respective number associated with a face value of one of the card symbols from the chosen amount of symbols; and
(d) enabling a player to play with the player set against at least one other player, each said player having at least one of their own player sets by drawing randomly the alphanumeric values to determine if the player's set of playing card symbols is generated first.

25. The method of claim 24, wherein enabling play includes comparing the generated alphanumeric values to the alphanumeric values of the player set to determine if a match occurs.

26. The method of claim 24, which includes converting the generated alphanumeric values to their respective playing card symbols and displaying the symbols if they match individually with one of the winning hands of playing card symbols.

27. The method of claim 24, wherein enabling play includes generating randomly values from the plurality of alphanumeric values, converting the generated values to their associated playing card symbols and comparing the converted playing card symbols with the winning hand of playing card symbols to determine if a match has occurred.

28. A method of conducting a bingo game involving a plurality of players, the method comprising:
forming a plurality of bingo cards by assigning a plurality of areas of each bingo card to corresponding non-bingo symbols;
mapping bingo numbers to areas of the bingo cards, wherein the mapping differs as to at least some areas of each bingo card;
providing at least some of the plurality of bingo cards to players, the plurality of areas of the bingo cards indicating the non-bingo symbols;
randomly drawing the bingo numbers;
indicating on each bingo card when a randomly drawn bingo number corresponds with a non-bingo symbol indicated on the bingo card; and
selecting a winning player who achieves a highest-ranking pattern of hits on the bingo card.

29. The method of claim 28, wherein the selecting step is part of a process of selecting a plurality of winning players who achieve predetermined patterns of hits on their bingo cards.

30. The method of claim 28, wherein the bingo cards are N×N bingo cards.

31. The method of claim 28, wherein the bingo cards are N×M bingo cards.

32. The method of claim 28, wherein the non-bingo symbols are playing card symbols.

33. The method of claim 28, wherein the forming step comprises forming the plurality of bingo cards by assigning a first plurality of areas of a first set of bingo cards to a first set of corresponding non-bingo symbols and assigning a second plurality of areas of a second set of bingo cards to a second set of corresponding non-bingo symbols.

34. The method of claim 29, wherein the predetermined patterns are interim win patterns.

35. The method of claim 29, wherein the predetermined patterns correspond to playing card hands.

36. The method of claim 30, wherein N is 5.

37. The method of claim 31, wherein N is 4 and M is 13.

38. The method of claim 31, wherein N is 13 and M is 4.

39. The method of claim 33, wherein the first set of bingo cards and the second set of bingo cards are used for a single game.

40. The method of claim 34, wherein the playing card hands are poker hands.
